(19) United States
(12) Patent Application Publication
(10) Pub. No.: US 2020/0056268 A1
(43) Pub. Date: Feb. 20, 2020

(54) ALUMINUM ALLOYS HAVING IRON AND RARE EARTH ELEMENTS

(71) Applicant: ARCONIC, INC., Pittsburgh, PA (US)

(72) Inventors: David W. Heard, Pittsburgh, PA (US); Jen C. Lin, Export, PA (US); Lynette M. Karabin, Ruffs Dale, PA (US); Cagatay Yanar, Pittsburgh, PA (US); Yijia Gu, Pittsburgh, PA (US); Albert L. Askin, Lower Burrell, PA (US); Zhi Tang, Pittsburgh, PA (US); Andreas Kulovits, Pittsburgh, PA (US)

(21) Appl. No.: 16/548,225

(22) Filed: Aug. 22, 2019

Related U.S. Application Data
(63) Continuation of application No. PCT/US2018/027622, filed on Apr. 13, 2018.
(60) Provisional application No. 62/485,259, filed on Apr. 13, 2017.
(60) Provisional application No. 62/541,524, filed on Aug. 4, 2017.
(60) Provisional application No. 62/558,220, filed on Sep. 13, 2017.

(51) Int. Cl. C22C 21/00; B33Y 70/00; C22F 1/04

(52) U.S. Cl. CPC C22C 21/00; B33Y 10/00; C22F 1/04; B33Y 70/00

(57) ABSTRACT

New aluminum alloys having iron and one or more rare earth elements are disclosed. The new alloys may include from 1 to 15 wt. % Fe and from 1 to 20 wt. % of the rare earth element(s), the balance aluminum and any optional incidental elements and impurities. The new aluminum alloys may be produced via additive manufacturing techniques.

### CROSS-REFERENCE TO RELATED APPLICATION

This application is a continuation of International Patent Application No. PCT/US2018/027622, filed Apr. 13, 2018, which claims the benefit of priority of U.S. Patent Application No. 62/485,259, filed Apr. 13, 2017, and claims the benefit of priority of U.S. Patent Application No. 62/541,524, filed Aug. 4, 2017; and claims the benefit of priority of U.S. Patent Application No. 62/558,220, filed Sep. 13, 2017, each of which is incorporated herein by reference in its entirety.

### BACKGROUND

Aluminum alloys are useful in a variety of applications. Aluminum alloy products are generally produced via either shape casting or wrought processes. Shape casting generally involves casting a molten aluminum alloy into its final form, such as via high pressure die, permanent mold, green and dry-sand, investment, or plaster casting. Wrought products are generally produced by casting a molten aluminum alloy into ingot or billet. The ingot or billet is generally further hot worked, sometimes with cold work, to produce its final form.

### SUMMARY OF THE INVENTION

Broadly, the present disclosure relates to new aluminum (Al) alloy bodies having iron (Fe) (and/or other transition metals, as described below) and rare earth (RE) elements. The new aluminum alloy bodies may realize an improved combination of properties, such as an improved combination of two or more of ductility, strength, thermal stability, creep resistance and fatigue failure resistance, among others. The new aluminum alloy bodies may be produced, for instance, via additive manufacturing.

In one approach, a method is provided and a method may include (a) using a feedstock in an additive manufacturing apparatus, wherein the feedstock comprises an alloy having from 1 to 15 wt. % Fe and from 1 to 20 wt. % of at least one rare earth (RE) element, the balance being aluminum and any optional incidental elements and impurities, and (b) producing an additively manufactured body in the additive manufacturing apparatus using the feedstock. In one embodiment, the additively manufactured body realizes a fine eutectic-type microstructure. In any of the above embodiments, the feedstock may comprise 5-11 wt. % Fe and 2.5-10 wt. % of the at least one rare earth element. In any of the above embodiments, the aluminum alloy body may realize a tensile yield strength-to-elongation relationship satisfying the following empirical relationship as measured at 230° C.: TYS≥−5.0808*(elongation)+22.274*(elongation)+337.08, when annealed at 300° C. for 24 hours followed by thermal exposure at 230° C. for 1000 hours. In any of the above embodiments, the at least one rare earth element may comprises at least cerium and lanthanum. In any of the above embodiments, the (wt. % Fe) plus the (wt. % of the at least one rare earth (RE) element) may be at least 9 wt. %. In any of the above embodiments, the feedstock may comprise from 0.1-5 wt. % of incidental elements, wherein the incidental elements comprise one or more grain refiners. In any of the above embodiments, the aluminum alloy product may be in the form of an engine component for an aerospace or automotive vehicle, wherein the method comprises incorporating the engine component into the aerospace or automotive vehicle. A method may include operating such an aerospace or automotive vehicle. In any of the above embodiments, the final aluminum alloy product may be a compressor wheel for a turbocharger. In any of the above embodiments, the final aluminum alloy product may be one of a heat exchanger and a piston. In any of the above embodiments, the method may comprise anodizing the aluminum alloy product, and wherein the anodizing is one of Type II or Type III anodization. In one embodiment, a method comprises sealing the anodized aluminum alloy product. In one embodiment, the anodized aluminum alloy product is in the form of a consumer electronics product. In any of the above embodiments, the alloy may include the iron and the rare earth element(s) such that RE (wt. %)≥−3.11(wt. % Fe)+13.4. In any of the above embodiments, the alloy may include the iron and the rare earth element(s) such that RE (wt. %)≤−3.11(wt. % Fe)+38. In any of the above embodiments, the alloy may include the iron and the rare earth element(s) such that RE (wt. %)≥−3.11(wt. % Fe)+18. In any of the above embodiments, the alloy may include the iron and the rare earth element(s) such that RE (wt. %)≤−3.11(wt. % Fe)+34.75.

In one approach, a product is provided and the product may be an additively manufactured aluminum alloy product comprising from 1 to 15 wt. % Fe and from 1 to 20 wt. % of at least one rare earth (RE) element, the balance being aluminum and any optional incidental elements and impurities. In one embodiment, an additively manufactured aluminum alloy product may realize a fine eutectic-type microstructure. In any of the above embodiments, an additively manufactured aluminum alloy product may comprise at least 2 wt. % Fe, or at least 3 wt. % Fe, or at least 4 wt. % Fe, or at least 5 wt. % Fe, or at least 6 wt. % Fe, or at least 7 wt. % Fe, or at least 7.5 wt. % Fe. In any of the above embodiments, an additively manufactured aluminum alloy product may comprise not greater than 14 wt. % Fe, or not greater than 13 wt. % Fe, or not greater than 12 wt. % Fe, or not greater than 11 wt. % Fe, or not greater than 10 wt. % Fe, or not greater than 9 wt. % Fe. In any of the above embodiments, an additively manufactured aluminum alloy product may comprise at least 2 wt. % of the at least one rare earth element, or at least 2.5 wt. % of the at least one rare earth element, or at least 3 wt. % of the at least one rare earth element. In any of the above embodiments, an additively manufactured aluminum alloy product may comprise not greater than 17.5 wt. % of the at least one rare earth element, or not greater than 15 wt. % of the at least one rare earth element, or not greater than 12.5 wt. % of the at least one rare earth element, or not greater than 12 wt. % of the at least one rare earth element, or not greater than 11 wt. % of the at least one rare earth element, or not greater than 10 wt. % of the at least one rare earth element, or not greater than 9 wt. % of the at least one rare earth element, or not greater than 8 wt. % of the at least one rare earth element, or not greater than 7 wt. % of the at least one rare earth element, or not greater than 6 wt. % of the at least one rare earth element. In any of the above embodiments, an additively manufactured aluminum alloy product may comprise at least 10 vol. % of Al—Fe-RE intermetallics, or at least 15 vol. % of Al—Fe-RE intermetallics, or at least 20 vol. % of Al—Fe-RE intermetallics, or at least 25 vol. % of Al—Fe-RE intermetallics, or at least 30 vol. % of Al—Fe-RE intermetallics. In any of the above embodiments, an additively manufactured aluminum alloy product may comprise not greater than 40 vol. % of Al—Fe-RE intermetallics. In any of the above embodiments, an additively manufactured aluminum alloy product may comprise not greater than 20 vol. % of large Al—Fe-RE spheroid particles, or not greater than 15 vol. % of large Al—Fe-RE spheroid particles, or not greater than 10 vol. % of large Al—Fe-RE spheroid particles, or not greater than 8 vol. % of large Al—Fe-RE spheroid particles, or not greater than 5 vol. % of large Al—Fe-RE spheroid particles, or not greater than 3 vol. % of large Al—Fe-RE spheroid particles. In any of the above embodiments, an additively manufactured aluminum alloy product may realize a tensile yield strength-to-elongation relationship satisfying the following empirical relationship as measured at 230° C.: TYS≥−5.0808*(elongation)+22.274*(elongation)+337.08, when annealed at 300° C. for 24 hours followed by thermal exposure at 230° C. for 1000 hours. In any of the above embodiments, an additively manufactured aluminum alloy product may comprise at least one of spheroidal, cellular, lamellar, wavy, and brick structures. In any of the above embodiments, an additively manufactured aluminum alloy product may be free of grain refiners. In any of the above embodiments, an additively manufactured aluminum alloy product may comprise columnar grains. In any of the above embodiments, an additively manufactured aluminum alloy product may comprise from 0.1 to 5 wt. % of one or more grain refiners. In any of the above embodiments, an additively manufactured aluminum alloy product may comprise equiaxed grains having an average grain size of from 0.05 to 50 microns. In any of the above embodiments, an additively manufactured product may include the iron and the rare earth element(s) such that RE (wt. %)≥−3.11(wt. % Fe)+13.4. In any of the above embodiments, an additively manufactured product may include the iron and the rare earth element(s) such that RE (wt. %)≤−3.11(wt. % Fe)+38. In any of the above embodiments, an additively manufactured product may include the iron and the rare earth element(s) such that RE (wt. %)≥−3.11(wt. % Fe)+18. In any of the above embodiments, an additively manufactured product may include the iron and the rare earth element(s) such that RE (wt. %)≤−3.11(wt. % Fe)+34.75. These and other inventive features, and combinations of inventive features, associated with the inventive methods and products described herein are also described in further detail below.

i. Composition

The new aluminum alloys generally comprise iron (Fe) (and/or other transition metals, as described in further detail, below) and one or more rare earth (RE) elements, the balance being aluminum, optional incidental elements, and unavoidable impurities. Some non-limiting examples of useful aluminum alloy compositions are shown in Table 1, below.

TABLE 1
Example Aluminum Alloys

| Alloy | Fe | Rare Earth(RE) | |
|---|---|---|---|
| Example | (wt. %) | Element(s)(wt. %) | Balance |
| Alloy 1 | 1-15 | 1-20 | Al, any incidental |
| | | | elements and impurities |
| Alloy 2 | 3-12 | 2-15 | Al, any incidental |
| | | | elements and impurities |
| Alloy 3 | 4-9 | 2.5-10 | Al, any incidental |
| | | | elements and impurities |
| Alloy 4 | 5-9 | 2.5-8 | Al, any incidental |
| | | | elements and impurities |
| Alloy 5 | 6-9 | 3-6 | Al, any incidental |
| | | | elements and impurities |
| Alloy 6 | 7.5-9 | 3-6 | Al, any incidental |
| | | | elements and impurities |
| Alloy 7 | 4-10 | 2.5-12 | Al, any incidental |
| | | | elements and impurities |
| Alloy 8 | 5-9 | 3-11 | Al, any incidental |
| | | | elements and impurities |
| Alloy 9 | 6-9 | 3-10 | Al, any incidental |
| | | | elements and impurities |
| Alloy 10 | 7-9 | 3-6 | Al, any incidental |
| | | | elements and impurities |

Optionally wherein:
RE (wt. %) ≥ −3.11(wt. % Fe) + 13.4, or RE (wt. %) ≥ −3.11(wt. % Fe) + 18;
and/or
RE (wt. %) ≤ −3.11(wt. % Fe) + 38 or RE (wt. %) ≤ −3.11(wt. % Fe) + 34.75.

In one approach, an aluminum alloy includes from 1 to 15 wt. % Fe. The use of iron facilitates, inter alia, high strength. In one embodiment, an aluminum alloy includes at least 2 wt. % Fe. In another embodiment, an aluminum alloy includes at least 3 wt. % Fe. In yet another embodiment, an aluminum alloy includes at least 4 wt. % Fe. In another embodiment, an aluminum alloy includes at least 5 wt. % Fe. In yet another embodiment, an aluminum alloy includes at least 6 wt. % Fe. In another embodiment, an aluminum alloy includes at least 7 wt. % Fe. In yet another embodiment, an aluminum alloy includes at least 7.5 wt. % Fe. In one embodiment, an aluminum alloy includes not greater than 14 wt. % Fe. In another embodiment, an aluminum alloy includes not greater than 13 wt. % Fe. In yet another embodiment, an aluminum alloy includes not greater than 12 wt. % Fe. In another embodiment, an aluminum alloy includes not greater than 11 wt. % Fe. In yet another embodiment, an aluminum alloy includes not greater than 10 wt. % Fe. In another embodiment, an aluminum alloy includes not greater than 9 wt. % Fe.

In one approach, an aluminum alloy includes from 1 to 20 wt. % of one or more rare earth elements. The use of rare earth element(s) facilitates, inter alfa, thermal stability. In one embodiment, an aluminum alloy includes at least 1.5 wt. % rare earth element(s). In another embodiment, an alloy includes at least 2 wt. % rare earth element(s). In yet another embodiment, an aluminum alloy includes at least 2.5 wt. % rare earth element(s). In yet another embodiment, an aluminum alloy includes at least 3 wt. % rare earth element(s). In one embodiment, an aluminum alloy includes not greater than 17.5 wt. % rare earth element(s). In another embodiment, an aluminum alloy includes not greater than 15 wt. % rare earth element(s). In yet another embodiment, an aluminum alloy includes not greater than 12.5 wt. % rare earth element(s). In another embodiment, an alloy includes not greater than 12 wt. % rare earth element(s). In yet another embodiment, an aluminum alloy includes not greater than 11 wt. % rare earth element(s). In another embodiment, an aluminum alloy includes not greater than 10 wt. % rare earth element(s). In yet another embodiment, an aluminum alloy includes not greater than 9 wt. % rare earth element(s). In another embodiment, an aluminum alloy includes not greater than 8 wt. % rare earth element(s). In yet another embodiment, an aluminum alloy includes not greater than 7 wt. % rare earth element(s). In another embodiment, an aluminum alloy includes not greater than 6 wt. % rare earth element(s).

The total amount of iron plus rare earth elements in the new aluminum alloys may facilitate realization of improved properties. The amount of iron plus rare earth elements relates to the amount of Al—Fe-RE intermetallics in the alloy. In one embodiment, the total amount of iron and rare earth elements within an aluminum alloy is at least 5 wt. % (i.e., (wt. % Fe) plus (wt. % rare earth elements)≥5 wt. %). In another embodiment, the total amount of iron and rare earth elements within an aluminum alloy is at least 6 wt. %. In yet another embodiment, the total amount of iron and rare earth elements within an aluminum alloy is at least 7 wt. %. In another embodiment, the total amount of iron and rare earth elements within an aluminum alloy is at least 8 wt. %. In yet another embodiment, the total amount of iron and rare earth elements within an aluminum alloy is at least 9 wt. %. In another embodiment, the total amount of iron and rare earth elements within an aluminum alloy is at least 10 wt. %. In one embodiment, an aluminum alloy includes at least 2 wt. % rare earth elements and at least 6 wt. % Fe. In another embodiment, an aluminum alloy includes at least 2.5 wt. % rare earth elements and at least 6 wt. % Fe. In another embodiment, a new alloy includes at least 3 wt. % rare earth elements and at least 6 wt. % Fe. In another embodiment, a new alloy includes at least 3 wt. % rare earth elements and at least 7 wt. % Fe.

As used herein, “Al—Fe-RE intermetallics” means intermetallic compounds having aluminum and at least one of iron and RE therein. Thus, the term “Al—Fe-RE intermetallics” includes Al—Fe compounds, Al-RE compounds, Al—Fe-RE compounds and combinations thereof. Some non-limiting examples of “Al—Fe-RE intermetallics” include, for instance, Al₁₃Fe₄, Al₃Fe, Al₆Fe, Al₃RE, Al₄RE, Al₁₁RE₃, Al₈Fe₄RE, and Al₁₀Fe₂RE, among other Al—Fe, Al-RE, Al—Fe-RE intermetallic compounds.

The new alloys described herein may realize an Fe-to-RE elements weight ratio of from 0.2 to 20:1 ((wt. % Fe):(wt. % RE element)). As noted in Table 1, above, the amount of iron and rare earth elements may optionally conform to one or both of the empirical relationships (1) and (2), below:

(1) RE (wt. %)≥−3.11(wt. % Fe)+13.4(**)

(2) RE (wt. %)≤−3.11(wt. % Fe)+38(**)

**Assume the amounts of iron and RE described herein are followed.

In one embodiment, the amount of iron and rare earth elements may conform to RE (wt. %)≥−3.11(wt. % Fe)+13.4. In one embodiment, the amount of iron and rare earth elements may conform to RE (wt. %)≤−3.11(wt. % Fe)+34.75.

As used herein, “rare earth elements” includes one or more of, for instance, scandium, yttrium and any of the fifteen lanthanides elements. The lanthanides are the fifteen metallic chemical elements with atomic numbers 57 through 71, from lanthanum through lutetium. In one embodiment, an alloy includes at least one of cerium (Ce) and lanthanum (La). In one embodiment, an alloy includes at least two rare earth elements. In another embodiment, an alloy includes at least both cerium and lanthanum. In one embodiment, an alloy includes misch metal. In one embodiment, the misch metal is a cerium-rich misch metal. In another embodiment, the misch metal is a lanthanum-rich misch metal. In one embodiment, the rare earth elements consist essentially of cerium and lanthanum. In one embodiment, the ratio of Ce:La is from about 0.15:1 to 6:1. In one embodiment, the ratio of Ce:La is at least 0.33:1. In another embodiment, the ratio of Ce:La is at least 0.67:1. In yet another embodiment, the ratio of Ce:La is at least 1:1. In another embodiment, the ratio of Ce:La is at least 1.25:1. In yet another embodiment, the ratio of Ce:La is at least 1.5:1. In one embodiment, the ratio of Ce:La is not greater than 5:1. In another embodiment, the ratio of Ce:La is not greater than 4:1. In yet another embodiment, the ratio of Ce:La is not greater than 3.5:1. In another embodiment, the ratio of Ce:La is not greater than 3:1.

As noted above, the balance of the aluminum alloy is aluminum and any optional incidental elements and impurities. As used herein, “incidental elements” includes casting aids and/or grain structure control materials (e.g., grain refiners), such as titanium, zirconium, and the like, that may be used in the aluminum alloy. Impurities may include, for instance, silicon.

As used herein, “grain refiner” means a nucleant or nucleants that facilitates alloy crystal formation. As it relates to the present alloying systems, a grain refiner may facilitate, inter alfa, formation of eutectic structures and/or primary phase solidification.

As noted above, one or more ceramic materials may be used in the aluminum alloy (e.g., to facilitate grain refinement and/or other desirable characteristics or properties). Examples of ceramics include, but are not limited to, oxide materials, boride materials, carbide materials, nitride materials, silicon materials, carbon materials, and/or combinations thereof. Some additional examples of ceramics include metal oxides, metal borides, metal carbides, metal nitrides and/or combinations thereof. Additionally, some non-limiting examples of ceramics include: TiB, TiB₂, TiC, SiC, Al₂O₃, BC, BN, Si₃N₄, Al₄C₃, AlN, their suitable equivalents, and/or combinations thereof. In one embodiment, TiB₂ is used in a new aluminum alloy.

As noted above, one or more other intermetallics (other than the Al—Fe-RE intermetallics) may be used in the alloy (e.g., to facilitate grain refinement and/or other desirable characteristics or properties). For instance, the compositions described herein may include materials that may facilitate the formation of the other intermetallics (e.g., during solidification). In this regard, non-limiting examples of such materials that may be used include titanium, zirconium, scandium, and hafnium, optionally in elemental form, among others.

While this section (i) has generally been described relative to the use of iron as the transition metal used in the new aluminum alloys, other transition metals may be used in lieu of or as a partial substitute for iron. For instance, one or more of chromium (Cr), manganese (Mn), cobalt (Co) and nickel (Ni) may be used in lieu or of or as a partial substitute for iron, and in any of the amounts identified above for the iron content of the new aluminum alloys.

In one embodiment, chromium fully replaces iron, and thus a new aluminum alloy may include from 1-15 wt. % Cr, with iron being present as an impurity. In another embodiment, chromium is partially substituted for iron, and thus a new aluminum alloy may include from 1-15 wt. % (Cr+Fe).

In one embodiment, manganese fully replaces iron, and thus a new aluminum alloy may include from 1-15 wt. % Mn, with iron being present as an impurity. In another embodiment, manganese is partially substituted for iron, and thus a new aluminum alloy may include from 1-15 wt. % (Mn+Fe).

In one embodiment, cobalt fully replaces iron, and thus a new aluminum alloy may include from 1-15 wt. % Co, with iron being present as an impurity. In another embodiment, cobalt is partially substituted for iron, and thus a new aluminum alloy may include from 1-15 wt. % (Co+Fe).

In one embodiment, nickel fully replaces iron, and thus a new aluminum alloy may include from 1-15 wt. % Ni, with iron being present as an impurity. In another embodiment, nickel is partially substituted for iron, and thus a new aluminum alloy may include from 1-15 wt. % (Ni+Fe).

While only combinations of two transition metals are shown above, three or more transition metals may be used in the new aluminum alloys, and the ranges and amounts described above apply to aluminum alloys having three or more transition metals.

When other transition metals are used in lieu of or in addition to iron, as described above, similar intermetallic compounds may be formed in the aluminum alloys. Thus, the term “Al—Fe-RE intermetallics” also includes chromium-containing, manganese-containing, cobalt-containing and nickel-containing intermetallic compounds, and irrespective of whether iron is contained in those compounds or not. Similarly, the recitation of any ranges or compositions relating to iron also specifically apply to aluminum alloys having chromium, manganese, cobalt and/or nickel, and irrespective of whether iron is included in such aluminum alloys. Thus, all of the ranges and amounts recited in the above paragraphs relating to iron, and including the ranges of Table 1, also apply equally to aluminum alloys having other transition metals of chromium, manganese, cobalt and/or nickel, and irrespective of whether iron is included in such aluminum alloys. Similarly, the weight ratio of from 0.2 to 20:1 ((wt. % Fe):(wt. % RE element)), also applies to all weight ratios for aluminum alloys having chromium, manganese, cobalt and/or nickel, and irrespective of whether iron is included in such aluminum alloys. Similarly, the optional boundaries of:

RE (wt. %)≥−3.11(wt. % Fe)+13.4, or RE (wt. %)≥−3.11(wt. % Fe)+18; and/or

RE (wt. %)≤−3.11(wt. % Fe)+38 or RE (wt. %)≤−3.11(wt. % Fe)+34.75

also apply equally to aluminum alloys having chromium, manganese, cobalt and/or nickel, and irrespective of whether iron is included in such aluminum alloys.
ii. Microstructure

As noted above, the amount of iron and rare earth elements of the new aluminum alloys may facilitate an improved combination of properties. In combination with appropriate solidification rates (e.g., those obtained by additive manufacturing processes) unique microstructures may be realized, which unique microstructures may at least partially contribute to the achievement of the improved properties. The amount of iron and rare earth elements within the aluminum alloy product may be varied relative to the desired amount of Al—Fe-RE intermetallics. In one embodiment, the amount of iron and rare earth elements contained within the aluminum alloy product is sufficient to provide for at least 10 vol. % of Al—Fe-RE intermetallics, and up to 40 vol. %, or more, of Al—Fe-RE intermetallics. In one embodiment, an aluminum alloy product having such Al—Fe-RE intermetallics may have a fine eutectic-type structure (defined below). The Al—Fe-RE intermetallics may facilitate, inter alia, strength and strength retention (thermal stability) in elevated temperature applications (e.g., for aerospace and/or automotive applications). The amount and type of Al—Fe-RE intermetallics in the aluminum alloy product may be determined by metallographically preparing a cross section through a final part, using a scanning electron microscope (SEM) with appropriate image analysis software to measure the area fraction of the Al—Fe-RE intermetallics, and, if appropriate, supplemented by a transmission electron microscope (TEM) analysis of a foil of the final part with appropriate image analysis software. In one embodiment, the amount of iron and rare earth elements contained within the aluminum alloy product may be sufficient to provide for at least 15 vol. % of Al—Fe-RE intermetallics. In another embodiment, the amount of iron and rare earth elements contained within the aluminum alloy product may be sufficient to provide for at least 20 vol. % of Al—Fe-RE intermetallics. In yet another embodiment, the amount of iron and rare earth elements contained within the aluminum alloy product may be sufficient to provide for at least 25 vol. % of Al—Fe-RE intermetallics. In another embodiment, the amount of iron and rare earth elements contained within the aluminum alloy product may be sufficient to provide for at least 30 vol. % of Al—Fe-RE intermetallics.

As noted above, the new aluminum alloy products may comprise a fine eutectic-type structure. As used herein, a “fine eutectic-type structure” means an alloy microstructure having regularly dispersed Al—Fe-RE intermetallics and comprising at least one of spheroidal, cellular, lamellar, wavy, brick and other suitable structures. In one embodiment, a fine eutectic-type structure comprises at least two of spheroidal, cellular, lamellar, wavy, brick or other suitable structures. As noted above, the spheroidal, cellular, lamellar, wavy, brick and/or other suitable structures may comprise Al—Fe-RE intermetallic compounds, and these Al—Fe-RE intermetallic compounds may make up, for instance, 10-40 vol. % of the final additively manufactured aluminum alloy product. In one embodiment, an aluminum alloy product comprises a fine eutectic-type structure having an average spacing between eutectic structures (“average eutectic spacing”) of not greater than 5 micrometers. In another embodiment, the average eutectic spacing is not greater than 4 micrometers. In yet another embodiment, the average eutectic spacing is not greater than 3 micrometers. In another embodiment, the average eutectic spacing is not greater than 2 micrometers. In yet another embodiment, the average eutectic spacing is not greater than 1 micrometers. In another embodiment, the average eutectic spacing is not greater than 0.5 micrometers. Fine eutectic-type structures may facilitate production of final products having a large volume fraction of Al—Fe-RE intermetallics therein (e.g., having 10-40 vol. % of Al—Fe-RE intermetallics), for instance, in the as built condition and after a thermal treatment or thermomechanical treatment.

As used herein, “average eutectic spacing” means the average spacing between the eutectic structures of the product as determined by the “Heyn Lineal Intercept Procedure” method described in ASTM standard E112-13, entitled, “Standard Test Methods for Determining Average Grain Size”, wherein the distance between eutectic structures is/are measured as opposed to the grains.

As noted above, a fine eutectic-type structure generally comprises at least one of spheroidal, cellular, lamellar, wavy, brick, or other suitable structures. With reference now to FIGS. 1, 2, and 8(a) through 16(b), illustrative examples of spheroidal structures (70) lamellar structures (80), wavy structures (90), brick structures (100), and cellular structures (110) are given. Additionally, FIG. 1 illustrates a melt pool boundary (120), and across the melt pool boundary, there is variation in the eutectic-type structures. See examples 1 and 3-4, below, for further information. The employment of grain refiner(s) may affect the final structure of the fine eutectic-type structure.

The new aluminum alloys described herein may realize a low volume fraction of large Al—Fe-RE intermetallics in the form of spheroidal particles, which are known to be detrimental to properties. As used herein, “large Al—Fe-RE spheroidal particles” means Al—Fe-RE intermetallics in the form of spheroidal particles and having a size of at least 100 nanometers, and wherein a particle's “size” is its maximum length in any dimension. For instance, an Al—Fe-RE spheroidal particle having a size of 103 nm in the “X-direction”, a size of 92 in the “Y-direction” and a size of 98.8, would be considered a “large Al—Fe-RE spheroidal particle” due to its size of 103 nm in the X-direction exceeding the threshold requirement of 100 nm. However, if the X-direction size of this particle were 95 nanometers, with the Y- and Z-direction sizes remaining unchanged, this particle would not be a “large Al—Fe-RE spheroidal particle” because no dimension exceeds the threshold requirement of 100 nm. In one embodiment, large Al—Fe-RE spheroidal particles are spheroidal particles having a size of at least 200 nanometers. In another embodiment, large Al—Fe-RE spheroidal particles are spheroidal particles having a size of at least 300 nanometers.

As noted above, the new aluminum alloys described herein may realize a low volume fraction of large Al—Fe-RE spheroidal particles. In one embodiment, an aluminum alloy product comprises not greater than 20 vol. % of large Al—Fe-RE spheroidal particles. In another embodiment, an aluminum alloy product comprises not greater than 15 vol. % of large Al—Fe-RE spheroidal particles. In another embodiment, an aluminum alloy product comprises not greater than 10 vol. % of large Al—Fe-RE spheroidal particles. In yet another embodiment, an aluminum alloy product comprises not greater than 8 vol. % of large Al—Fe-RE spheroidal particles. In another embodiment, an aluminum alloy product comprises not greater than 5 vol. % of large Al—Fe-RE spheroidal particles. In yet another embodiment, an aluminum alloy product comprises not greater than 3 vol. % of large Al—Fe-RE spheroidal particles.

As noted above, the aluminum alloy products may be produced using one or more incidental elements, such as one or more grain refiners (grain refiner(s)). In one embodiment, an aluminum alloy product comprises grain refiners(s). The grain refiner(s) may facilitate production of, for instance, crack-free additively manufactured aluminum alloy products and/or aluminum alloy products with improved mechanical properties (e.g., improved ductility). In one embodiment, the feedstock comprises a sufficient amount of the grain refiner(s) to facilitate production of a crack-free additively manufactured product. The grain refiner(s) may facilitate, for instance, production of an additively manufactured aluminum alloy product having generally equiaxed grains. However, excessive grain refiner(s) may decrease the strength of the additively manufactured aluminum alloy product. Thus, in one embodiment, a feedstock comprises a sufficient amount of grain refiner(s) to facilitate production of a crack-free additively manufactured aluminum alloy product, but the amount of grain refiner(s) in the aluminum-based product is limited so that the additively manufactured aluminum-based product retains its strength (e.g., tensile yield strength (TYS) and/or ultimate tensile strength (UTS)). For instance, the amount of grain refiner(s) may be limited such that the strength of a grain refiner-containing aluminum alloy product is close to the same aluminum alloy product having no grain refiners. In one embodiment, the strength of a grain refiner-containing aluminum alloy product is within 10 ksi of the same aluminum alloy product without the grain refiner(s). In another embodiment, the strength of a grain refiner-containing aluminum alloy product is within 8 ksi of the same aluminum alloy product without the grain refiner(s). In yet another embodiment, the strength of a grain refiner-containing aluminum alloy product is within 6 ksi of the same aluminum alloy product without the grain refiner(s). In yet another embodiment, the strength of a grain refiner-containing aluminum alloy product is within 4 ksi of the same aluminum alloy product without the grain refiner(s). In another embodiment, the strength of a grain refiner-containing aluminum alloy product is within 2 ksi of the same aluminum alloy product without the grain refiner(s). In yet another embodiment, the strength of a grain refiner-containing aluminum alloy product is within 1 ksi of the same aluminum alloy product without the grain refiner(s). In one embodiment, the strength of a grain refiner-containing aluminum alloy product is within 15% of the same aluminum without the grain refiner(s). In another embodiment, the strength of a grain refiner-containing aluminum alloy product is within 12% of the same aluminum alloy product without the grain refiner(s). In yet another embodiment, the strength of a grain refiner-containing aluminum alloy product is within 9% of the same aluminum alloy product without the grain refiner(s). In another embodiment, the strength of a grain refiner-containing aluminum alloy product is within 6% of the same aluminum alloy product without the grain refiner(s). In yet another embodiment, the strength of a grain refiner-containing aluminum alloy product is within 3% of the same aluminum alloy product without the grain refiner(s). In one embodiment, an additively manufactured aluminum alloy product comprises 0.1-5 wt. %, in total, of grain refiner(s). In another embodiment, an additively manufactured aluminum alloy product comprises 0.5-3 wt. %, in total, of grain refiner(s). In another embodiment, an additively manufactured aluminum alloy product comprises 1-3 wt. %, in total, of grain refiner(s). The appropriate amount of grain refiner(s) may facilitate improved properties, such as increased strength, reduced segregation, reduced thermal and solidification shrinkage, and increased ductility, among others. Furthermore, the appropriate amount of grain refiner(s) may restrict and/or prevent cracking (e.g., during additive manufacturing). In one embodiment, an additively manufactured aluminum alloy product comprises grain refiner(s), wherein the grain refiner(s) comprise TiB₂.

As used herein, “equiaxed grains” means grains having an average aspect ratio of less than 4:1 as measured in the XY, YZ, and XZ planes. The “aspect ratio” is determined using commercial software Edax OIM version 8.0 or equivalent. The commercial software fits an ellipse to the perimeter points of the grain. As used herein, “aspect ratio” is the inverse of: the length of the minor axis of the ellipse divided by the length of the major axis of the ellipse as determined using commercial software. In one embodiment, an additively manufactured aluminum alloy part comprises equiaxed grains having an average aspect ratio of less than 4:1. In one embodiment, an additively manufactured aluminum alloy part comprises equiaxed grains having an average aspect ratio of not greater than 3:1. In one described embodiment, an additively manufactured aluminum alloy part comprises equiaxed grains having an average aspect ratio of not greater than 2:1. In one embodiment, an additively manufactured aluminum alloy part comprises equiaxed grains having an average aspect ratio of not greater than 1.5:1. In one embodiment, an additively manufactured aluminum alloy part comprises equiaxed grains having an average aspect ratio of not greater than 1.1:1. The amount (volume percent) of equiaxed grains in the additively manufactured product in the as-built condition may be determined by EBSD (electron backscatter diffraction) analysis of a suitable number of SEM micrographs of the additively manufactured-product in the as-built condition. Generally at least 5 micrographs should be analyzed.

As used herein, “grain” takes on the meaning defined in ASTM E112 § 3.2.2, i.e., “the area within the confines of the original (primary) boundary observed on the two-dimensional plane of-polish or that volume enclosed by the original (primary) boundary in the three-dimensional object”.

As used herein, the “grain size” is calculated by the following equation:

$$vi = square root ( \frac{4 Ai}{pi} )$$

wherein Ai is the area of the individual grain as measured using commercial software Edax OIM version 8.0 or equivalent; and
wherein vi is the calculated individual grain size assuming the grain is a circle.
   Grain size is determined based on a two-dimensional plane that includes the build direction of the additively manufactured product.

As used herein, the “area weighted average grain size” is calculated by the following equation:

v-bar=(Σᵢ₌₁ⁿ Aivi)/(Σᵢ₌₁ⁿ Ai)
wherein Ai is the area of each individual grain as measured using commercial software Edax OIM version 8.0 or equivalent;
wherein vi is the calculated individual grain size assuming the grain is a circle; and
wherein v-bar is the area weighted average grain size.

As used herein, the “as-built condition” means the condition of the additively manufactured aluminum alloy product after production and absent of any subsequent mechanical, thermal or thermomechanical treatments.

Additively manufactured products that comprise equiaxed grains may realize, for instance, improved ductility and/or strength, among others. In this regard, equiaxed grains may help facilitate the realization of improved ductility and/or strength, among others. In one embodiment, an additively manufactured aluminum alloy product comprises equiaxed grains, wherein the average grain size is of from 0.05 to 50 microns. Use of grain refiners may help facilitate production of additively manufactured products having equiaxed grains.

In one embodiment, an additively manufactured aluminum alloy product in the as-built condition comprises grains and at least 50 vol. % of the grains are equiaxed grains. In another embodiment, an additively manufactured aluminum alloy product in the as-built condition comprises at least 60 vol. % of equiaxed grains. In yet another embodiment, an additively manufactured aluminum alloy product in the as-built condition comprises at least 70 vol. % of equiaxed grains. In another embodiment, an additively manufactured aluminum alloy product in the as-built condition comprises at least 80 vol. % of equiaxed grains. In yet another embodiment, an additively manufactured aluminum alloy product in the as-built condition comprises at least 90 vol. % of equiaxed grains. In another embodiment, an additively manufactured aluminum alloy product in the as-built condition comprises at least 95 vol. % of equiaxed grains. In yet another embodiment, an additively manufactured aluminum alloy product in the as-built condition comprises at least 99 vol. % of equiaxed grains, or more.

As noted above, the average size of equiaxed grains of the additively manufactured aluminum alloy product in the as-built condition is generally not greater than 50 microns. In one embodiment, the average size of the equiaxed grains of the additively manufactured aluminum alloy product in the as-built condition is not greater than 40 microns. In another embodiment, the average size of the equiaxed grains of the additively manufactured aluminum alloy product in the as-built condition is not greater than 30 microns. In yet another embodiment, the average size of the equiaxed grains of the additively manufactured aluminum alloy product in the as-built condition is not greater than 20 microns. In another embodiment, the average size of the equiaxed grains of the additively manufactured aluminum alloy product in the as-built condition is not greater than 10 microns. In yet another embodiment, the average size of the equiaxed grains of the additively manufactured aluminum alloy product in the as-built condition is not greater than 5 microns. In another embodiment, the average size of the equiaxed grains of the additively manufactured aluminum alloy product in the as-built condition is not greater than 4 microns. In yet another embodiment, the average size of the equiaxed grains of the additively manufactured aluminum alloy product in the as-built condition is not greater than 3 microns. In another embodiment, the average size of the equiaxed grains of the additively manufactured aluminum alloy product in the as-built condition is not greater than 2 microns, or less.

In some embodiments, the additively manufactured product is a crack-free product. In some embodiments, “crack-free” means that the product is sufficiently free of cracks such that it can be used for its intended, end-use purpose. The determination of whether a product is “crack-free” may be made by any suitable method, such as, by visual inspection, dye penetrant inspection, and/or by non-destructive test methods. In some embodiments, the non-destructive test method is a computed topography scan (“CT scan”) inspection (e.g., by measuring density differences within the product). In one embodiment, an aluminum alloy product is determined to be crack-free by visual inspection. In another embodiment, an aluminum alloy product is determined to be crack-free by dye penetrant inspection. In yet another embodiment, an aluminum alloy product is determined to be crack-free by CT scan inspection, as evaluated in accordance with ASTM E1441. In another embodiment, an aluminum alloy product is determined to be crack-free during an additive manufacturing process, wherein in situ monitoring of the additively manufactured build is employed.

As noted above, the aluminum alloy products may include an amount of grain refiner(s) sufficient to facilitate production of crack-free additively manufactured products having equiaxed grains. In one embodiment, the grain refiner(s) make up 0.1-5 wt. %, in total, of a crack-free additively manufactured aluminum alloy product. In another embodiment, the grain refiner(s) make up 0.5-3 wt. %, in total, of a crack-free additively manufactured aluminum alloy product. In yet another embodiment, the grain refiner(s) make up 1-3 wt. %, in total, of a crack-free additively manufactured aluminum alloy product.

In some embodiments, the aluminum alloy products comprise columnar grains (defined below). In one embodiment, an aluminum alloy product is free of grain refiner(s), and comprises columnar grains.

As used herein, “columnar grains” means grains having an average aspect ratio of at least 4:1 as measured in the YZ and/or XZ planes, wherein the Z plane is the build direction. The “aspect ratio” is determined using commercial software Edax OIM version 8.0 or equivalent. The commercial software fits an ellipse to the perimeter points of the grain. In one embodiment, columnar grains have an average aspect ratio of at least 5:1. In another embodiment, columnar grains have an average aspect ratio of at least 6:1. In yet another embodiment, columnar grains have an average aspect ratio of at least 7:1. In another embodiment, columnar grains have an average aspect ratio of at least 8:1. In yet another embodiment, columnar grains have an average aspect ratio of at least 9:1. In another embodiment, columnar grains have an average aspect ratio of at least 10:1.

iii. Processing

The new aluminum alloys may be made via any suitable processing route. In one embodiment, the new aluminum alloys are in a cast form such as in the form of an ingot or billet (e.g., for using in making atomized powders). In one embodiment, the processing route involves rapid solidification (e.g., to facilitate production of fine eutectic-type microstructures), such as high-pressure die casting and some continuous castings techniques. In one embodiment, the new aluminum alloys are additively manufactured, as described below. In one embodiment, the new aluminum alloys are in the form of powders or wires (e.g., for use in an additive manufacturing process).

### Additive Manufacturing

The aluminum alloys described herein may be used in additive manufacturing to produce an additively manufactured aluminum alloy body. As used herein, “additive manufacturing” means, “a process of joining materials to make objects from 3D model data, usually layer upon layer, as opposed to subtractive manufacturing methodologies”, as defined in ASTM F2792-12a entitled “Standard Terminology for Additively Manufacturing Technologies”. Additively manufactured aluminum alloy bodies may be manufactured via any appropriate additive manufacturing technique described in this ASTM standard, such as binder jetting, directed energy deposition, material extrusion, material jetting, powder bed fusion, or sheet lamination, among others. Any suitable feedstocks may be used, including one or more powders, one or more wires, and combinations thereof. In some embodiments the additive manufacturing feedstock is comprised of one or more powders. In some embodiments, the additive manufacturing feedstock is comprised of one or more wires.

In one embodiment, an additive manufacturing process includes depositing successive layers of one or more powders and then selectively melting and/or sintering the powders to create, layer-by-layer, an additively manufactured aluminum alloy body (product). In one embodiment, an additive manufacturing processes uses one or more of Selective Laser Sintering (SLS), Selective Laser Melting (SLM), and Electron Beam Melting (EBM), among others. In one embodiment, an additive manufacturing process uses an EOSINT M 280 Direct Metal Laser Sintering (DMLS) additive manufacturing system, or comparable system, available from EOS GmbH (Robert-Stirling-Ring 1, 82152 Krailling/Munich, Germany). In one embodiment, additive manufacturing process uses a LENS additive manufacturing system, or comparable system, available from OPTOMEC, 3911 Singer N.E., Albuquerque, N. Mex. 87109.

As one example, a feedstock, such as a powder or wire, comprising (or consisting essentially of) the Al, the Fe, the rare earth element(s), and any optional incidental elements and impurities, and within the scope of the compositions described above, may be used in an additive manufacturing apparatus to produce an additively manufactured aluminum alloy body. In some embodiments, the additively manufactured aluminum alloy body is a crack-free preform. The feedstock may be selectively heated above the liquidus temperature of the material, thereby forming a molten pool having the Al, the Fe, the rare earth element(s), and any optional incidental elements and impurities, followed by rapid solidification of the molten pool thereby forming an additively manufactured aluminum alloy product, generally with 10-40% vol. % of Al—Fe-RE intermetallics therein. The additively manufactured aluminum alloy product may realize a fine eutectic-type microstructure.

As noted above, additive manufacturing may be used to create, layer-by-layer, the aluminum alloy product. In one embodiment, a metal powder bed is used to create a tailored aluminum alloy product. As used herein a “metal powder bed” means a bed comprising a metal powder. During additive manufacturing, particles of the same or different compositions may melt (e.g., rapidly melt) and then solidify (e.g., in the absence of homogenous mixing). Thus, products having a homogenous or non-homogeneous microstructure may be produced. One embodiment of a method of making an additively manufactured aluminum alloy body may include (a) dispersing a powder comprising the Al, the Fe, the rare earth element(s), and any optional incidental elements and impurities, (b) selectively heating a portion of the powder (e.g., via a laser) to a temperature above the liquidus temperature of the particular body to be formed, (c) forming a molten pool having the Al, the Fe, the rare earth element(s), and any optional incidental elements and impurities, and (d) cooling the molten pool at a cooling rate of at least 1000° C. per second. In one embodiment, the cooling rate is at least 10,000° C. per second. In another embodiment, the cooling rate is at least 100,000° C. per second. In another embodiment, the cooling rate is at least 1,000,000° C. per second. Steps (a)-(d) may be repeated as necessary until the aluminum alloy body is completed, i.e., until the final additively manufactured aluminum alloy body is formed/completed. The final additively manufactured aluminum alloy body may be of a complex geometry, or may be of a simple geometry (e.g., in the form of a sheet or plate), and may comprise 10-40% vol. % of Al—Fe-RE intermetallics therein, and may realize a fine eutectic-type microstructure. After or during production, an additively manufactured aluminum alloy product may be deformed (e.g., by one or more of rolling, extruding, forging, stretching, compressing).

The powders used to additively manufacture an aluminum alloy body may be produced by atomizing a material (e.g., an ingot or melt) of the new alloy aluminum alloys into powders of the appropriate dimensions relative to the additive manufacturing process to be used. As used herein, “powder” means a material comprising a plurality of particles. Powders may be used in a powder bed to produce a tailored alloy product via additive manufacturing. In one embodiment, the same general powder is used throughout the additive manufacturing process to produce an aluminum alloy product. For instance, the final tailored aluminum alloy product may comprise a single region/matrix produced by using generally the same metal powder during the additive manufacturing process. The final tailored aluminum alloy product may alternatively comprise at least two separately produced distinct regions. In one embodiment, different metal powder bed types may be used to produce the aluminum alloy product. For instance, a first metal powder bed may comprise a first metal powder and a second metal powder bed may comprise a second metal powder, different than the first metal powder. The first metal powder bed may be used to produce a first layer or portion of the alloy product, and the second metal powder bed may be used to produce a second layer or portion of the alloy product. As used herein, a “particle” means a minute fragment of matter having a size suitable for use in the powder of the powder bed (e.g., a size of from 5 microns to 100 microns). Particles may be produced, for example, via atomization.

The additively manufactured aluminum alloy body may be subject to any appropriate working steps. If employed, the working steps may be conducted on an intermediate form of the additively manufactured body and/or may be conducted on a final form of the additively manufactured body. In one embodiment, an additively manufactured body consists essentially of the Al, the Fe, the rare earth element(s), and any optional incidental elements and impurities, such as any of the material compositions described above.

In another embodiment, an aluminum alloy body is a preform for subsequent working. A preform may be an additively manufactured product. In one embodiment, a preform is of a near net shape product that is close to the final desired shape of the final product, but the preform is designed to allow for subsequent working to achieve the final product shape. Thus, the preform may worked such as by forging, rolling, extrusion, or hipping to produce an intermediate product or a final product, which intermediate or final product may be subject to any further appropriate working or thermal steps (e.g., stress relief), as described above, to achieve the final product. In one embodiment, the working comprises hot isostatic pressing (hipping) to compress the part. In one embodiment, an aluminum alloy preform may be compressed and porosity may be reduced. In one embodiment, the hipping temperature is maintained below the incipient melting point of the aluminum alloy preform. In one embodiment, the preform may be a near net shape product.

In one approach, electron beam (EB) or plasma arc techniques are utilized to produce at least a portion of the additively manufactured aluminum alloy body. Electron beam techniques may facilitate production of larger parts than readily produced via laser additive manufacturing techniques. In one embodiment, a method comprises feeding a small diameter wire (e.g., ≤5 mm in diameter) of the new aluminum alloys described herein to the wire feeder portion of an electron beam gun. The wire may be of the compositions, described above. The electron beam (EB) heats the wire above the liquidus point of the body to be formed, followed by rapid solidification (e.g., at least 100° C. per second) of the molten pool to form the deposited material. The wire could be fabricated by a conventional ingot process or by a powder consolidation process. These steps may be repeated as necessary until the final aluminum alloy body is produced. Plasma arc wire feed may similarly be used with the aluminum alloys disclosed herein. In one embodiment, not illustrated, an electron beam (EB) or plasma arc additive manufacturing apparatus may employ multiple different wires with corresponding multiple different radiation sources, each of the wires and sources being fed and activated, as appropriate to provide the aluminum alloy product.

In another approach, a method may comprise (a) selectively spraying one or more metal powders of the new aluminum alloys described herein towards a building substrate, (b) heating, via a radiation source, the metal powders, and optionally the building substrate, above the liquidus temperature of the product to be formed, thereby forming a molten pool, (c) cooling the molten pool, thereby forming a solid portion of the product, wherein the cooling comprises cooling at a cooling rate of at least 100° C. per second. In one embodiment, the cooling rate is at least 1000° C. per second. In another embodiment, the cooling rate is at least 10,000° C. per second. The cooling step (c) may be accomplished by moving the radiation source away from the molten pool and/or by moving the building substrate having the molten pool away from the radiation source. Steps (a)-(c) may be repeated as necessary until the product is completed. The spraying step (a) may be accomplished via one or more nozzles, and the composition of the metal powders can be varied, as appropriate, to provide a tailored final aluminum alloy product. The composition of the metal powder being heated at any one time can be varied in real-time by using different powders in different nozzles and/or by varying the powder composition(s) provided to any one nozzle in real-time. The work piece can be any suitable substrate. In one embodiment, the building substrate is, itself, a metal product (e.g., an alloy product, such as any of the aluminum alloy products described herein.)

iv. Properties

The new aluminum alloy bodies described herein may realize an improved combination of properties. As used below in this section, “annealing” means annealing at 300° C. for 24 hours. All mechanical properties are measured in a direction orthogonal to the build direction.

In one embodiment, a new aluminum alloy body of the new aluminum alloys described herein (a “new alloy body”) realizes a room temperature tensile yield strength (TYS) of at least 400 MPa after annealing. In one embodiment, a new alloy body realizes a room temperature TYS of at least 415 MPa after annealing. In one embodiment, a new alloy body realizes a room temperature TYS of at least 430 MPa after annealing. In any of these embodiments, the new alloy body may realize a room temperature ultimate tensile strength (UTS) of at least 500 MPa. In any of these embodiments, the new alloy body may realize a room temperature UTS of at least 530 MPa. In any of these embodiments, the new alloy body may realize a room temperature UTS of at least 560 MPa. In any of these embodiments, the new alloy body may realize a room temperature UTS of at least 580 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a room temperature TYS of at least 400 MPa after annealing followed by thermal exposure at 175° C. for 100 hours. In one embodiment, a new alloy body realizes a room temperature TYS of at least 420 MPa after annealing and this thermal exposure. In one embodiment, a new alloy body realizes a room temperature TYS of at least 440 MPa after annealing and this thermal exposure. In any of these embodiments, the new alloy body may realize a room temperature UTS of at least 500 MPa. In any of these embodiments, the new alloy body may realize a room temperature UTS of at least 530 MPa. In any of these embodiments, the new alloy body may realize a room temperature UTS of at least 560 MPa. In any of these embodiments, the new alloy body may realize a room temperature UTS of at least 580 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a room temperature TYS of at least 400 MPa after annealing followed by thermal exposure at 230° C. for 100 hours. In one embodiment, a new alloy body realizes a room temperature TYS of at least 420 MPa after annealing and this thermal exposure. In one embodiment, a new alloy body realizes a room temperature TYS of at least 440 MPa after annealing and this thermal exposure. In any of these embodiments, the new alloy body may realize a room temperature UTS of at least 500 MPa. In any of these embodiments, the new alloy body may realize a room temperature UTS of at least 530 MPa. In any of these embodiments, the new alloy body may realize a room temperature UTS of at least 560 MPa. In any of these embodiments, the new alloy body may realize a room temperature UTS of at least 580 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a room temperature TYS of at least 390 MPa after annealing followed by thermal exposure at 300° C. for 100 hours. In one embodiment, a new alloy body realizes a room temperature TYS of at least 410 MPa after annealing and this thermal exposure. In one embodiment, a new alloy body realizes a room temperature TYS of at least 430 MPa after annealing and this thermal exposure. In any of these embodiments, the new alloy body may realize a room temperature UTS of at least 480 MPa. In any of these embodiments, the new alloy body may realize a room temperature UTS of at least 515 MPa. In any of these embodiments, the new alloy body may realize a room temperature UTS of at least 545 MPa. In any of these embodiments, the new alloy body may realize a room temperature UTS of at least 570 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a 175° C. TYS of at least 350 MPa after annealing followed by thermal exposure at 175° C. for 0.5 hour. In one embodiment, a new alloy body realizes a 175° C. TYS of at least 370 MPa after annealing and this thermal exposure. In one embodiment, a new alloy body realizes a 175° C. TYS of at least 390 MPa after annealing and this thermal exposure. In any of these embodiments, the new alloy body may realize a 175° C. UTS of at least 420 MPa. In any of these embodiments, the new alloy body may realize a 175° C. UTS of at least 440 MPa. In any of these embodiments, the new alloy body may realize a 175° C. UTS of at least 460 MPa. In any of these embodiments, the new alloy body may realize a 175° C. UTS of at least 480 MPa. In any of these embodiments, the new alloy body may realize an elongation of at least 4%. In any of these embodiments, the new alloy body may realize an elongation of at least 6%. In any of these embodiments, the new alloy body may realize an elongation of at least 8%. In any of these embodiments, the new alloy body may realize an elongation of at least 10%.

In one embodiment, a new alloy body realizes a 175° C. TYS of at least 350 MPa after annealing followed by thermal exposure at 175° C. for 100 hours. In one embodiment, a new alloy body realizes a 175° C. TYS of at least 370 MPa after annealing and this thermal exposure. In one embodiment, a new alloy body realizes a 175° C. TYS of at least 390 MPa after annealing and this thermal exposure. In any of these embodiments, the new alloy body may realize a 175° C. UTS of at least 420 MPa. In any of these embodiments, the new alloy body may realize a 175° C. UTS of at least 440 MPa. In any of these embodiments, the new alloy body may realize a 175° C. UTS of at least 460 MPa. In any of these embodiments, the new alloy body may realize a 175° C. UTS of at least 480 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a 175° C. TYS of at least 350 MPa after annealing followed by thermal exposure at 175° C. for 1000 hours. In one embodiment, a new alloy body realizes a 175° C. TYS of at least 370 MPa after annealing and this thermal exposure. In one embodiment, a new alloy body realizes a 175° C. TYS of at least 390 MPa after annealing and this thermal exposure. In any of these embodiments, the new alloy body may realize a 175° C. UTS of at least 420 MPa. In any of these embodiments, the new alloy body may realize a 175° C. UTS of at least 440 MPa. In any of these embodiments, the new alloy body may realize a 175° C. UTS of at least 460 MPa. In any of these embodiments, the new alloy body may realize a 175° C. UTS of at least 480 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a 230° C. TYS of at least 300 MPa after annealing followed by thermal exposure at 230° C. for 0.5 hour. In one embodiment, a new alloy body realizes a 230° C. TYS of at least 325 MPa after annealing and this thermal exposure. In one embodiment, a new alloy body realizes a 230° C. TYS of at least 350 MPa after annealing and this thermal exposure. In any of these embodiments, the new alloy body may realize a 230° C. UTS of at least 375 MPa. In any of these embodiments, the new alloy body may realize a 230° C. UTS of at least 400 MPa. In any of these embodiments, the new alloy body may realize a 230° C. UTS of at least 415 MPa. In any of these embodiments, the new alloy body may realize a 230° C. UTS of at least 425 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a 230° C. TYS of at least 300 MPa after annealing followed by thermal exposure at 230° C. for 100 hours. In one embodiment, a new alloy body realizes a 230° C. TYS of at least 325 MPa after annealing and this thermal exposure. In one embodiment, a new alloy body realizes a 230° C. TYS of at least 350 MPa after annealing and this thermal exposure. In any of these embodiments, the new alloy body may realize a 230° C. UTS of at least 375 MPa. In any of these embodiments, the new alloy body may realize a 230° C. UTS of at least 400 MPa. In any of these embodiments, the new alloy body may realize a 230° C. UTS of at least 415 MPa. In any of these embodiments, the new alloy body may realize a 230° C. UTS of at least 425 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a 230° C. TYS of at least 300 MPa after annealing followed by thermal exposure at 230° C. for 1000 hours. In one embodiment, a new alloy body realizes a 230° C. TYS of at least 325 MPa after annealing and this thermal exposure. In one embodiment, a new alloy body realizes a 230° C. TYS of at least 350 MPa after annealing and this thermal exposure. In any of these embodiments, the new alloy body may realize a 230° C. UTS of at least 375 MPa. In any of these embodiments, the new alloy body may realize a 230° C. UTS of at least 400 MPa. In any of these embodiments, the new alloy body may realize a 230° C. UTS of at least 415 MPa. In any of these embodiments, the new alloy body may realize a 230° C. UTS of at least 425 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a 300° C. TYS of at least 250 MPa after annealing followed by thermal exposure at 300° C. for 0.5 hour. In one embodiment, a new alloy body realizes a 300° C. TYS of at least 270 MPa after annealing and this thermal exposure. In one embodiment, a new alloy body realizes a 300° C. TYS of at least 290 MPa after annealing and this thermal exposure. In any of these embodiments, the new alloy body may realize a 300° C. UTS of at least 290 MPa. In any of these embodiments, the new alloy body may realize a 300° C. UTS of at least 310 MPa. In any of these embodiments, the new alloy body may realize a 300° C. UTS of at least 325 MPa. In any of these embodiments, the new alloy body may realize a 300° C. UTS of at least 335 MPa. In any of these embodiments, the new alloy body may realize an elongation of at least 4%. In any of these embodiments, the new alloy body may realize an elongation of at least 6%. In any of these embodiments, the new alloy body may realize an elongation of at least 8%. In any of these embodiments, the new alloy body may realize an elongation of at least 10%.

In one embodiment, a new alloy body realizes a 300° C. TYS of at least 240 MPa after annealing followed by thermal exposure at 300° C. for 100 hours. In one embodiment, a new alloy body realizes a 300° C. TYS of at least 260 MPa after annealing and this thermal exposure. In one embodiment, a new alloy body realizes a 300° C. TYS of at least 280 MPa after annealing and this thermal exposure. In any of these embodiments, the new alloy body may realize a 300° C. UTS of at least 280 MPa. In any of these embodiments, the new alloy body may realize a 300° C. UTS of at least 295 MPa. In any of these embodiments, the new alloy body may realize a 300° C. UTS of at least 305 MPa. In any of these embodiments, the new alloy body may realize a 300° C. UTS of at least 315 MPa. In any of these embodiments, the new alloy body may realize an elongation of at least 4%. In any of these embodiments, the new alloy body may realize an elongation of at least 5%. In any of these embodiments, the new alloy body may realize an elongation of at least 6%.

In one embodiment, a new alloy body realizes a 300° C. TYS of at least 210 MPa after annealing followed by thermal exposure at 300° C. for 1000 hours. In one embodiment, a new alloy body realizes a 300° C. TYS of at least 230 MPa after annealing and this thermal exposure. In one embodiment, a new alloy body realizes a 300° C. TYS of at least 250 MPa after annealing and this thermal exposure. In any of these embodiments, the new alloy body may realize a 300° C. UTS of at least 250 MPa. In any of these embodiments, the new alloy body may realize a 300° C. UTS of at least 265 MPa. In any of these embodiments, the new alloy body may realize a 300° C. UTS of at least 280 MPa. In any of these embodiments, the new alloy body may realize a 300° C. UTS of at least 295 MPa. In any of these embodiments, the new alloy body may realize an elongation of at least 4%. In any of these embodiments, the new alloy body may realize an elongation of at least 6%. In any of these embodiments, the new alloy body may realize an elongation of at least 8%.

In one approach, a new aluminum alloy body realizes an elevated temperature strength-to-elongation performance of TYS≥−5.0808*(elongation)²+22.274*(elongation)+337.08 at an elongation of 2-7% and after annealing followed by 1000 hours of thermal exposure at 230° C., wherein the properties of the aluminum alloy body are measured at 230° C. In one embodiment, a new aluminum alloy body realizes an elevated temperature strength-to-elongation performance of TYS≥−5.0808*(elongation)²+22.274*(elongation)+353.9, wherein the properties of the aluminum alloy body are measured at 230° C. In another embodiment, a new aluminum alloy body realizes an elevated temperature strength-to-elongation performance of TYS≥−5.0808*(elongation)²+22.274*(elongation)+370.8, wherein the properties of the aluminum alloy body are measured at 230° C. In another embodiment, a new aluminum alloy body realizes an elevated temperature strength-to-elongation performance of TYS≥−5.0808*(elongation)²+22.274*(elongation)+387.6, wherein the properties of the aluminum alloy body are measured at 230° C. In yet another embodiment, a new aluminum alloy body realizes an elevated temperature strength-to-elongation performance of TYS≥−5.0808*(elongation)²+22.274*(elongation)+387.6, wherein the properties of the aluminum alloy body are measured at 230° C. In another embodiment, a new aluminum alloy body realizes an elevated temperature strength-to-elongation performance of TYS≥−5.0808*(elongation)²+22.274*(elongation)+404.5, wherein the properties of the aluminum alloy body are measured at 230° C. In yet another embodiment, a new aluminum alloy body realizes an elevated temperature strength-to-elongation performance of TYS≥−5.0808*(elongation)²+22.274*(elongation)+411.2, wherein the properties of the aluminum alloy body are measured at 230° C.

In one embodiment, a new aluminum alloy body realizes improved fatigue failure resistance. In one embodiment, a new aluminum alloy body achieves at least 1,000,000 cycles prior to failure when its fully reversed fatigue is tested in accordance with ASTM E466 at a temperature of 230° C., a maximum stress of 130 MPa, a frequency of 50 Hz, and an R of −1.

In one embodiment, a new aluminum alloy body realizes improved creep resistance. In one embodiment, a new aluminum alloy body achieves at least equivalent creep resistance as compared to a 2618-T651 plate. In another embodiment, a new aluminum alloy body achieves at least 5% better creep resistance as compared to a 2618-T651 plate as determined by comparing the stress for equivalent creep rupture time at a particular temperature for the new aluminum alloy and the 2618-T651 plate. In yet another embodiment, a new aluminum alloy body achieves at least 10% better creep resistance as compared to a 2618-T651 plate as determined by comparing the stress for equivalent creep rupture time at a particular temperature for the new aluminum alloy and the 2618-T651 plate.

v. Anodizing

Methods of producing anodized aluminum alloy bodies from the above-described aluminum alloys are also disclosed, one embodiment of which is illustrated in FIG. 5. In the illustrated embodiment, the method (500) includes the steps of preparing an aluminum alloy body of the new aluminum alloys described herein for oxide layer formation (520), electrochemically forming an oxide layer in the aluminum alloy body (540), optionally dying the aluminum alloy body (560), and one or more optional post-dye processes (580).

The preparing step (520) may include any number of steps useful in preparing the aluminum alloy body for formation of the electrochemically formed oxide layer. For example, and as described in further detail below, the preparing step (520) may include producing the aluminum alloy body (e.g., via additive manufacturing), cleaning the body, and/or chemically brightening the body.

The step of electrochemically forming the oxide layer in the body (540) may be accomplished via any suitable apparatus or processes, such as anodizing. Anodizing may be performed using a variety of different process parameters including current density, bath composition, time, and temperature. In one approach, the anodizing is Type II anodizing and in accordance with MIL-A-8625. In another embodiment, the anodizing is Type III anodizing, per MIL-A-8625. Additional anodizing information is provided below.

The optional step of dying the body (560) may include immersing the body in one or more dye baths, with optional rinsing between and/or after the dying steps.

The optional post-dye processes (580) may include sealing the dyed aluminum alloy body and/or polishing the dyed aluminum alloy body, as described in further detail below.

One particular embodiment of producing an aluminum alloy body of the new aluminum alloys described herein is illustrated in FIG. 6. In the illustrated embodiment, the method (500) includes the steps of preparing the aluminum alloy body for anodizing (520), anodizing the aluminum alloy body (540), dying the aluminum alloy body (560), and one or more optional post-dye processes (580).

In the illustrated embodiment, the step of preparing the aluminum alloy body for anodizing (520) includes the steps of producing the aluminum alloy body (522), cleaning the aluminum alloy body (524), and brightening (e.g., electrochemically polishing, or chemical polishing) the aluminum alloy body (526).

With respect to the step of producing the aluminum alloy body (522), the aluminum alloy body may be produced via any suitable aluminum alloy production processes, as described above.

With respect to the cleaning step (524), this cleaning may be accomplished by any known conventional processes and/or cleaning agents, such as via the use of acidic and/or basic cleansers or detergents that produce a water break free surface (water wettable). In one embodiment, the cleaning agent is a non-alkaline cleaner, such as A-31K manufactured by Henkel International, Germany. For example, the cleaning step (524) may include cleaning the intended viewing surface of the aluminum alloy body with a non-etching alkaline cleaner for about two minutes to remove lubricants or other residues that may have formed during the bright-rolling step. After the cleaning step (524), the body may be rinsed or double rinsed with a suitable rinsing agent, such as water. In one embodiment, the suitable rinsing agent is de-ionized water. Other suitable rinsing agents may be utilized.

With respect to the brightening step (526), the brightening may include electrochemical or chemical polishing. The electrochemical polishing may be accomplished via any suitable processes, such as via use of an electrolyte in the presence of current. Some methods of electrochemical polishing are disclosed in U.S. Pat. No. 4,740,280, which is incorporated herein by reference in its entirety. The chemical brightening (polishing) may be accomplished via any suitable processes, such as via a mixture of phosphoric acid and nitric acid in the presence of water, or via the methods described in U.S. Pat. No. 6,440,290 to Vega et al., which is incorporated herein by reference in its entirety. For example, the brightening step (526) may include chemical etching by immersing in a phosphoric acid-based solution (e.g., DAB80) for a period of about two minutes to about four minutes, followed by a warm bath double rinse similar to that discussed above, immersion in a 50% nitric acid solution at room temperature for about thirty seconds, and another double rinse step.

In one embodiment, the brightening step (526) may include mechanical polishing by grinding, roughing, oiling or greasing, buffing or mopping, and coloring, among other suitable mechanical processes.

As used herein, “polishing” and the like means to smooth or brighten a surface to increase the reflective quality and luster, such as mechanical polishing by grinding, polishing and buffing, or to improve the surface conditions of the aluminum product for decorative or functional purposes. For example, mechanical polishing may be utilized to increase gloss. In one embodiment, an aluminum alloy body of the new aluminum alloys described herein may be first bright rolled followed by mechanical polishing to produce high image clarity at the intended viewing surface of the aluminum alloy body.

With respect to the anodizing step (540), the anodizing may be accomplished via any suitable electrolyte and current density. In one embodiment, the anodizing step includes utilizing an electrolyte having 12 to 25 wt. % H₂SO₄, a current density of 8 to 36 amps per square foot (ASF), and with an electrolyte temperature of between 60° F. to 80° F.

As used herein, “anodizing” and the like means those processes that produce an oxide zone of a selected thickness in a body via application of current to the body while the body is in the presence of an electrolyte.

In one embodiment, the electrolyte comprises at least 12 wt. % sulfuric acid, such as at least 14 wt. % sulfuric acid. In one embodiment, the electrolyte comprises not greater than 25 wt. % sulfuric acid. In other embodiments, the electrolyte comprises not greater than 22 wt. % sulfuric acid, or not greater than 20 wt. % sulfuric acid.

In some embodiments, the electrolyte includes at least one of phosphoric acid, boric/sulfuric acid, chromic acid, and oxalic acid, among other suitable acid mediums.

In one embodiment, the current density during anodizing is at least about 8 ASF. In other embodiments, the current density is at least about 10 ASF or at least about 12 ASF. In one embodiment, the current density is not greater than about 24 ASF. In other embodiments, the current density is not greater than about 20 ASF, or not greater than about 18 ASF.

In one embodiment, the temperature of the electrolyte during anodizing is at least about 40° F. In other embodiments, the temperature of the electrolyte during anodizing is at least about 50° F., such as at least about 60° F. In one embodiment, the temperature of the electrolyte during anodizing is not greater than about 100° F. In other embodiments, the temperature of the electrolyte during anodizing is not greater than 90° F., such as not greater than 80° F.

In one embodiment, the anodizing step (540) produces an electrochemically formed oxide zone in the body, the electrochemically formed oxide zone having a thickness of from 0.05 to 1.5 mil.

In one embodiment, after the anodizing step (540), the aluminum alloy body may be subjected to a double rinse step, followed by immersion in a 50% nitric acid solution at room temperature for about 60 seconds, and another double rinse step.

With respect to the dying step (560), the dying may include an optional first dying step (562), and optionally at least one additional dying step (566). In one embodiment, the optional dying step (560) includes at least two dying steps. Additional dying sequences may be used.

As used herein, “dye” and the like means a color material used for coloring a body. Dyes may be any suitable color, such as red, orange, yellow, green, blue, indigo, violet, black, white, and mixtures thereof. Dyes are usually water-based, and placed in contact with bodies via immersion techniques. However, dyes may be applied to the body in other ways, such as, for example, via spraying, spraying-immersion, and the like. Irrespective of the manner of application of the dye, the dye should contact the surface of the oxide zone of the aluminum alloy body for a sufficient amount of time to enable the pores of the oxide zone to retain the dye (e.g., via absorption).

In one embodiment, the dye is an aqueous-based dye. Examples of suitable dyes include those produced by Clariant, Pigments and Additives Division, 500 Washington Street, Coventry, R.I., 02816 United States (www.pa.clariant.com).

With respect to the optional post-dye processes (580), such processes may include one or more of sealing the dyed aluminum alloy body (582) and polishing the aluminum alloy body (584).

With respect to the sealing step (582), the sealing may be useful to close the oxide pores or prevent the color of the dyes from bleeding or leaking out of the oxide zone. The sealing step can be accomplished via any known conventional processes, such as by hot sealing with de-ionized water or steam or by cold sealing with impregnation of a sealant in a room-temperature bath. In one approach, at least some, or in some instances all or nearly all, of the pores of the oxide zone may be sealed with a sealing agent, such as, for instance, an aqueous salt solution at elevated temperature (e.g., boiling salt water) or nickel acetate. After the sealing step the body may again be double rinsed with a rinsing agent.

With respect to the polishing step (584), the polishing may be accomplished via any suitable means so as to increase, for example, the gloss of the aluminum alloy body.

vi. Applications

As previously stated, the new materials described above may be suitable for elevated temperature applications. For instance, the new aluminum alloy bodies of the new aluminum alloys described herein may be suitable in aerospace and/or automotive applications. Non-limiting examples of aerospace applications may include heat exchangers and turbines (e.g., turbocharger impeller wheels). Non-limiting examples of automotive applications may include interior or exterior trim/appliques, pistons, valves, and/or turbochargers. Other examples include any components close to a hot area of the vehicle, such as engine components and/or exhaust components, such as the manifold.

Aside from the applications described above, the new aluminum alloy bodies of the present disclosure may also be utilized in a variety of consumer products, such as any consumer electronic products, including laptops, cell phones, cameras, mobile music players, handheld devices, computers, televisions, microwave, cookware, washer/dryer, refrigerator, sporting goods, or any other consumer electronic product requiring durability and selective visual appearance. In one embodiment, the visual appearance of the consumer electronic product meets consumer acceptance standards.

In some embodiments, the new aluminum alloy bodies of the present disclosure may be utilized in a variety of products including non-consumer products including the likes of medical devices, transportation systems and security systems, to name a few. In other embodiments, the new aluminum alloy bodies may be incorporated in goods including the likes of car panels, media players, bottles and cans, office supplies, packages and containers, among others.

The figures constitute a part of this specification and include illustrative embodiments of the present disclosure and illustrate various objects and features thereof. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references, unless the context clearly dictates otherwise. The meaning of “in” includes “in” and “on”, unless the context clearly dictates otherwise.

### BRIEF DESCRIPTION OF THE DRAWINGS

FIGS. 1-2 are SEM images of an as-built and stress-relieved Al-8Fe-2.5Ce-1.5La aluminum alloy body of Example 1.

FIG. 3 is a plot showing the properties of the Example 1 alloys versus the properties of alloys described in U.S. Pat. No. 4,379,719.

FIG. 4(a) is a TEM image of a prior art alloy described in the article Dispersion Strengthened Al—Fe—Ce: A Dual Rapid Solidification/Mechanical Alloying Approach, Ezz, S.S. et al., from the book Dispersion Strengthened Aluminum Alloys, Kim and Griffith (Eds.), 1998, pp. 243-263.

FIG. 4(b) is a TEM image of an Example 1 alloy.

FIG. 4(c) is an SEM image of an Example 1 alloy.

FIG. 5 is a flow chart illustrating one embodiment of a method for producing an anodized, optionally dyed, and optionally post-dye processed aluminum alloy body of the new aluminum alloys described herein.

FIG. 6 is a flow chart illustrating one embodiment of a method for producing an anodized, optionally dyed, and optionally post-dye processed aluminum alloy body of the new aluminum alloys described herein.

FIG. 7(a) is an image of an anodized Example 2 alloy consumer electronics case that has been clear-sealed in nickel acetate.

FIG. 7(b) is an image of an anodized Example 2 alloy consumer electronics case that has been dyed black and clear-sealed in nickel acetate.

FIG. 8(a) is a scanning electron microscope micrograph of Alloy 1 from Example 3 in the as re-melted condition.

FIG. 8(b) is a scanning electron microscope micrograph of Alloy 1 from Example 3 in a thermally treated condition, where the thermal treatment included exposing the alloy to a temperature of 300° C. for 100 hours.

FIG. 9(a) is a scanning electron microscope micrograph of Alloy 4 from Example 3 in the as re-melted condition.

FIG. 9(b) is a scanning electron microscope micrograph of Alloy 4 from Example 3 in a thermally treated condition, where the thermal treatment included exposing the alloy to a temperature of 300° C. for 100 hours.

FIG. 10(a) is a scanning electron microscope micrograph of Alloy 8 from Example 3 in the as re-melted condition.

FIG. 10(b) is a scanning electron microscope micrograph of Alloy 8 from Example 3 in a thermally treated condition, where the thermal treatment included exposing the alloy to a temperature of 300° C. for 100 hours.

FIG. 11(a) is a scanning electron microscope micrograph of Alloy 10 from Example 3 in the as re-melted condition.

FIG. 11(b) is a scanning electron microscope micrograph of Alloy 10 from Example 3 in a thermally treated condition, where the thermal treatment included exposing the alloy to a temperature of 300° C. for 100 hours.

FIG. 12(a) is a scanning electron microscope micrograph of Alloy 11 from Example 3 in the as re-melted condition.

FIG. 12(b) is a scanning electron microscope micrograph of Alloy 11 from Example 3 in a thermally treated condition, where the thermal treatment included exposing the alloy to a temperature of 300° C. for 100 hours.

FIG. 13(a) is a scanning electron microscope micrograph of Alloy 14 from Example 3 in the as re-melted condition.

FIG. 13(b) is a scanning electron microscope micrograph of Alloy 14 from Example 3 in a thermally treated condition, where the thermal treatment included exposing the alloy to a temperature of 300° C. for 100 hours.

FIG. 14(a) is a scanning electron microscope micrograph of Alloy 15 from Example 4 in the as re-melted condition.

FIG. 14(b) is a scanning electron microscope micrograph of Alloy 15 from Example 4 in a thermally treated condition, where the thermal treatment included exposing the alloy to a temperature of 300° C. for 100 hours.

FIG. 15(a) is a scanning electron microscope micrograph of Alloy 16 from Example 4 in the as re-melted condition.

FIG. 15(b) is a scanning electron microscope micrograph of Alloy 16 from Example 4 in a thermally treated condition, where the thermal treatment included exposing the alloy to a temperature of 300° C. for 100 hours.

FIG. 16(a) is a scanning electron microscope micrograph of Alloy 17 from Example 4 in the as re-melted condition.

FIG. 16(b) is a scanning electron microscope micrograph of Alloy 17 from Example 4 in a thermally treated condition, where the thermal treatment included exposing the alloy to a temperature of 300° C. for 100 hours.

### DETAILED DESCRIPTION

### EXAMPLE 1

An Al—Fe—Ce—La alloy powder was used to produce various additively manufactured products. The products were additively manufactured (AM) via powder bed fusion (PBF) using an EOS M280 machine. Chemical analysis of the powder and the as-built components (final products) was conducted via inductively coupled plasma (ICP), the results of which are shown in Table 1, below (all values in weight percent).

TABLE 2
Compositions

| Item | Fe | Ce | La | Balance* |
|---|---|---|---|---|
| Starting powder | 8.1 | 2.5 | 1.4 | Al and imp. |
| As-Built | 8.08 +/− 0.01 | 2.58 +/− 0.01 | 1.5 +/− 0.01 | Al and imp. |
| Components** | | | | |

*The impurities were less than 0.03 wt. % each, except for Si which was less than 0.2 wt. %, and total impurities were less than 0.50 wt. %
**Average composition of two as-built components with standard deviation shown as +/−.

After production, the additively manufactured products were annealed at 300° C. for 24 hours. Some of the alloy bodies were then exposed to various elevated temperature conditions. The mechanical properties of the alloys were then tested, the results of which are shown in Table 3, below. Tensile testing was performed on specimens that were machined from rectangular blanks produced on an EOSM280 built in the XY plane (orthogonal to the build direction), in accordance with the ASTM E8 standard. Tensile testing was performed both at room-temperature as well as at elevated temperatures ranging from 175 to 300° C. The elevated temperature tensile tests were performed after various thermal exposure durations. The thermal exposure durations ranged from 0.5 to 1000 hours, and the exposure temperatures ranged from 175 to 300° C. All of the thermal exposures, with the exception of the 0.5 hour exposure specimens, were performed by placing the specimens within a convection furnace for the prescribed duration. The specimens were then placed in the tensile load-frame and heated to the desired test temperature, and held at the desired temperature for 30 minutes before performing the tensile test. The 0.2% offset yield strength (TYS), ultimate tensile strength (UTS), and elongation (Elong.) to failure were determined in accordance with ASTM E8 and B557. All reported values are the average of duplicate specimens, unless otherwise indicated.

TABLE 3
Properties of Example 1 Alloys

| | Exposure | Exposure | Test | | | |
|---|---|---|---|---|---|---|
| Test | Temp. | Time | Temp. | TYS | UTS | Elong. |
| No. | (° C.) | (hr.) | (° C.) | (MPa) | (MPa) | (%) |
| 1 | N/A - Room Temp. | | 20 | 429.5 | 580.5 | 6 |
| 2* | N/A - Room Temp. | | 20 | 442 | 592 | 4 |
| 3 | 175 | 100 | 20 | 443 | 587 | 5 |
| 4 | 230 | 100 | 20 | 440.5 | 588 | 5 |
| 5 | 300 | 100 | 20 | 426.5 | 569.5 | 6 |
| 6 | 175 | 0.5 | 175 | 388 | 476.5 | 10 |
| 7 | 230 | 0.5 | 230 | 357.5 | 424 | 4 |
| 8 | 300 | 0.5 | 300 | 287.5 | 335 | 10 |
| 9 | 175 | 100 | 175 | 392.5 | 471 | 5 |
| 10 | 230 | 100 | 230 | 348 | 418.5 | 5 |
| 11 | 300 | 100 | 300 | 274.5 | 318.5 | 5 |
| 12* | 175 | 1000 | 175 | 395 | 470 | 6 |
| 13 | 230 | 1000 | 230 | 352 | 423 | 6 |
| 14 | 300 | 1000 | 300 | 248 | 295.5 | 8 |

*Reported values from a single specimen only

The density of the as-built components was determined using an Archimedes density analysis procedure involving weighing the component in air, followed by submerging the component in water and weighing the component while it is submerged, and under controlled conditions. The Archimedes density is then calculated using Equation 1 below,

$${ρ}_{0} = \frac{{W}_{a} {ρ}_{w} - {W}_{w} {ρ}_{a}}{{W}_{a} - {W}_{w}} \qquad ( Equation 1 )$$

where ρ₀ is the density of the unknown component, Wₐ and W_{w} are the weight of the component in air and water respectively, and ρₐ and ρ_{w} are the density of air and water respectively. The Archimedes analysis revealed that densities in excess of 99% of the theoretical density were obtained within the as-built components.

The microstructure of the as-built components was analyzed via optical metallography (OM), scanning electron microscopy (SEM), electron probe microanalysis (EPMA), and transmission electron microscopy (TEM). OM was performed on specimens prepared by mounting sections of the as-built specimens in Bakelite and then grinding and polishing using a combination of polishing media. The OM analysis revealed less than 1% porosity to be present within the specimens, thereby confirming the Archimedes density results.

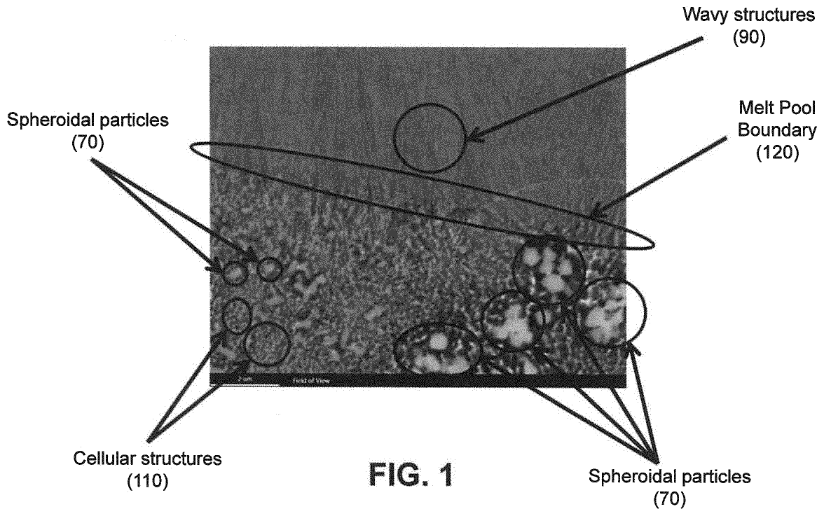

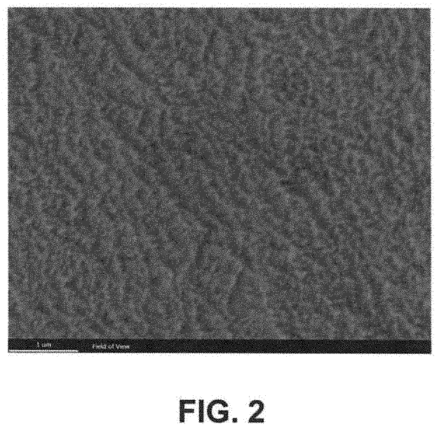

SEM imaging was performed using the same specimens prepared for OM analysis and revealed the presence of both a fine spheroidal phase and a fine cellular phase, representative images of which are shown in FIGS. 1-2. FIG. 1 shows the Al-8Fe-2.5Ce-1.5La aluminum alloy in the as-built and stress relieved condition, and having various region types. FIG. 2 shows the Al-8Fe-2.5Ce-1.5La aluminum alloy in the as-built and stress relieved condition, and having a fine wavy structure. EPMA reveals that the fine phases are enriched in iron (Fe) and contained some cerium (Ce) and lanthanum (La), and are believed to be of the Al₁₀Fe₂(Ce,La) or Al₈Fe₄(Ce,La) type.

Transmission electron microscopy (TEM) was employed to determine the composition of the cell walls. Electron transparent TEM foils were prepared from as-built specimens by mechanically thinning the specimens prior to applying a final electrojet polishing step using a solution consisting of nitric acid (HNO₃) and methanol with an applied voltage of 20-30 volts. The TEM analysis revealed the cell walls to be enriched in cerium (Ce), lanthanum (La), and iron (Fe).

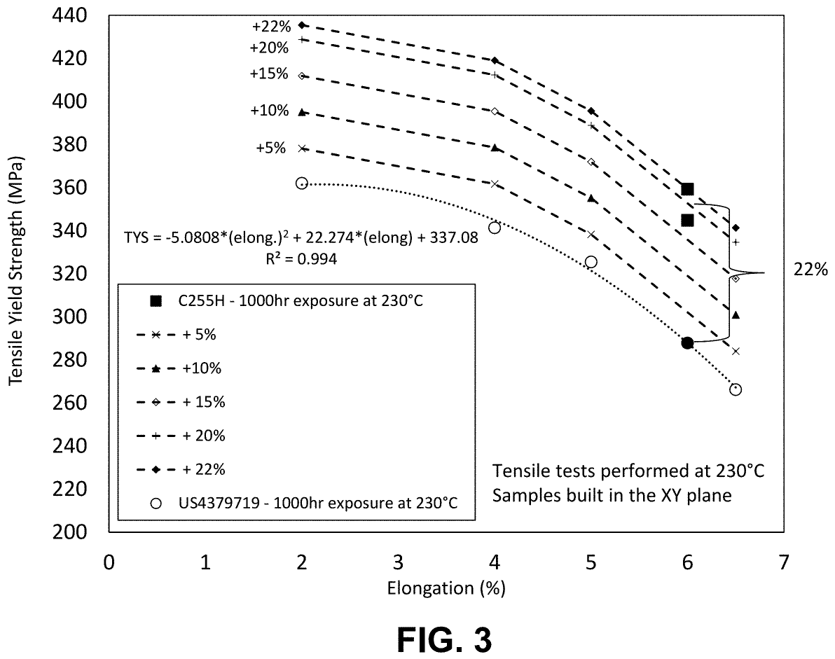

FIG. 3 compares the results of the new alloys versus the alloys of U.S. Pat. No. 4,379,719. As shown, the combination of yield strength and ductility (elongation-to-failure) obtained by the new alloy bodies is significantly better. For instance, test alloy 13 of Example 1 realized an average tensile yield strength of about 352 MPa at 6% elongation. This is an increase of over 22% over the prior art aluminum alloys at equivalent elongation.

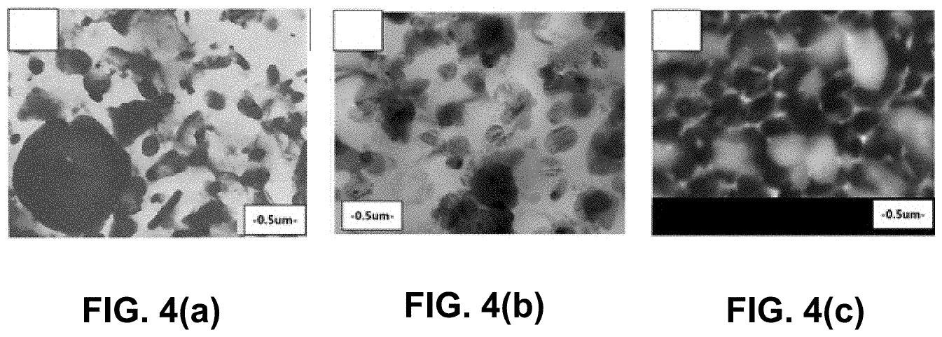

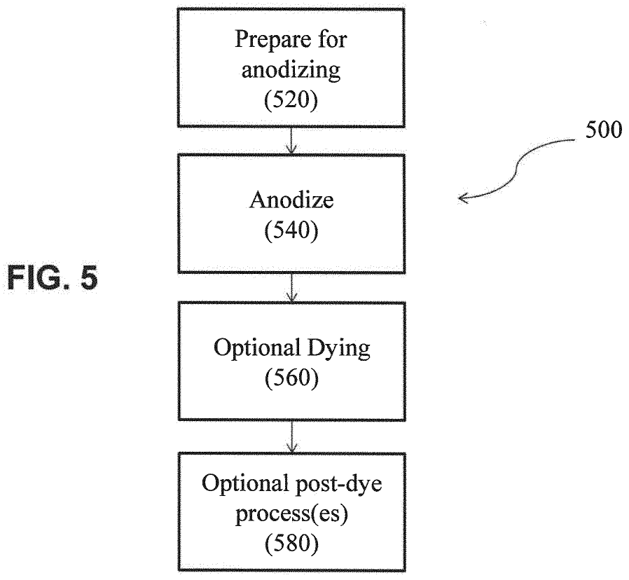

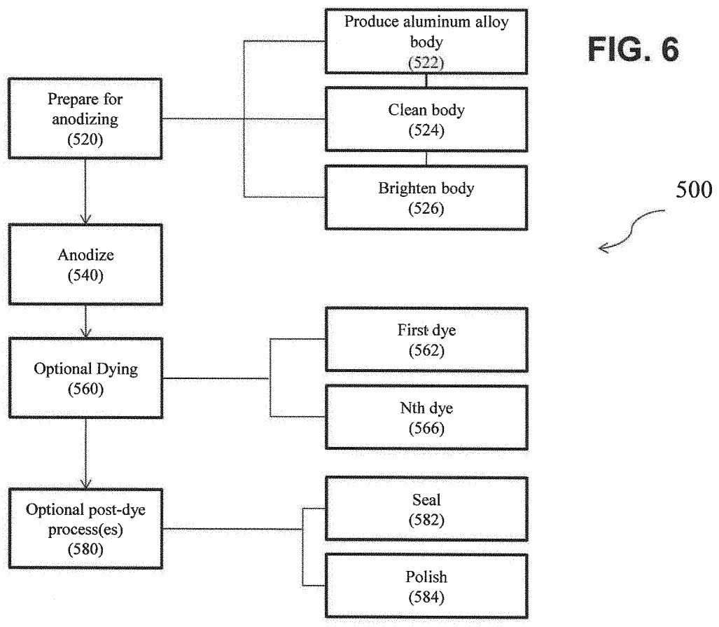

FIG. 4(a) is a micrograph of a prior art alloy made by conventional powder metallurgy (PM) processing. The prior art alloy shows large spherical or elongated intermetallics (which are rich in Fe and Ce). The prior art alloy also lacks a fine eutectic-type microstructure. FIGS. 4(b)-(c) are TEM and SEM images respectively, of the new alloy from Example 1, having a fine eutectic-type structure, which, it is believed, contributes to the high strength and elongation properties of the new alloys. Thus, in some embodiments, the additively-manufactured product comprises a fine eutectic-type structure (e.g., in the as-built condition (defined above) and/or in a thermally exposed condition).

### EXAMPLE 2

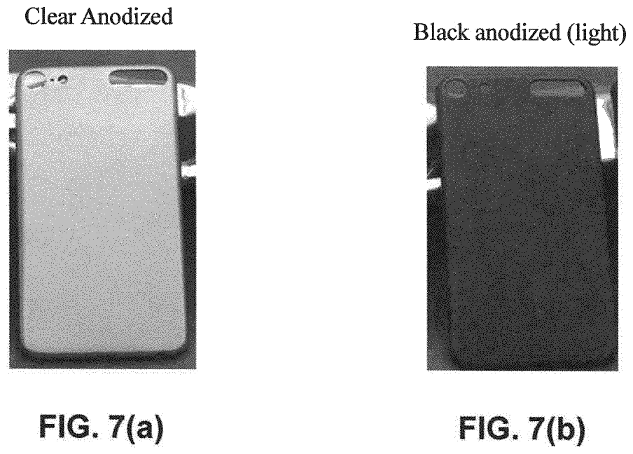

An alloy consistent with the as-built alloy described in Example 1 was used to additively manufacture several consumer electronics cases. The consumer electronic cases were additively manufactured in an EOS M280 metal powder bed apparatus. The additively manufactured consumer electronic cases were then stress relieved at 300° C. for 2 hours, and then mechanically polished and blasted to remove any residual surface defects. Next, the consumer electronic cases were cleansed in a non-etching alkaline solution, and then bright dipped (e.g., consistent with the brightening processes disclosed in U.S. Pat. No. 6,440,290). Next, the bright dipped consumer electronic cases were rinsed with water then Type II anodized. The Type II anodization was performed using a current density of 12 ASF in a 15 wt. % sulfur acid bath (pH<1.0) at 68-72° F., for 80 minutes. The process realized an anodic oxide layer of approximately 0.8 mils (20 microns) in thickness. Following anodization, the consumer electronic cases were rinsed in water. A first anodized and rinsed electronic consumer case was sealed in a nickel acetate solution, absent of dying, and is shown in FIG. 7(a). A second anodized and rinsed consumer electronic case was dyed black using a Clariant dye (Clariant, Pigments and Additives Division, 500 Washington Street, Coventry, R.I., 02816 United States (www.pa.clariant.com)) and then sealed in a nickel acetate solution, and is shown in FIG. 7(b). As shown, the cell phone case exhibits an aesthetically pleasing, non-directional deep black surface with acceptable durability.

### EXAMPLE 3

Fourteen experimental alloys were cast as book mold ingots, and a portion of the ingots were then re-melted and solidified to simulate an additive manufacturing process. The tendency for the experimental alloys to crack was then evaluated using micrograph inspection. Actual compositions of the experimental alloys were evaluated using inductively coupled plasma atomic emission spectroscopy, the results of which are given in Table 4, below.

TABLE 4
Experimental Alloy Compositions (in wt. %) *

| Alloy No. | Fe | Ce | La | Ce + La | Fe + RE |
|---|---|---|---|---|---|
| Alloy 1 | 6.7 | 3.6 | 1.9 | 5.5 | 12.2 |
| Alloy 2 | 5.3 | 1.8 | 1.1 | 2.9 | 8.2 |
| Alloy 3 | 5.6 | 3.4 | 2.1 | 5.5 | 11.1 |
| Alloy 4 | 5.7 | 5.1 | 2.4 | 7.5 | 13.2 |
| Alloy 5 | 8.2 | 1.9 | 1.0 | 2.9 | 11.1 |
| Alloy 6 | 8.5 | 3.4 | 2.0 | 5.4 | 13.9 |
| Alloy 7 | 8.0 | 4.7 | 2.7 | 7.4 | 15.4 |
| Alloy 8 | 4.7 | 1.4 | 0.67 | 2.07 | 6.77 |
| Alloy 9 | 4.9 | 3.7 | 2.0 | 5.7 | 10.6 |
| Alloy 10 | 4.9 | 6.7 | 3.1 | 9.8 | 14.7 |
| Alloy 11 | 10 | 1.3 | 0.74 | 2.04 | 12.04 |
| Alloy 12 | 9.6 | 3.8 | 1.9 | 5.7 | 15.3 |
| Alloy 13 | 9.4 | 6.1 | 3.3 | 9.4 | 18.8 |
| Alloy 14 | 7.5 | 2.3 | 1.6 | 3.9 | 11.4 |

* The balance of the alloys was aluminum and impurities.

As noted above, the experimental alloys were re-melted using a laser to simulate additive manufacturing processes. In this regard, the solidification conditions employed in the re-melting facilitated solidification rates on the order of 1,000,000° C./s. Microhardness of the re-melted experimental alloys was evaluated in the as re-melted condition (i.e., a simulated “as-built” condition), as well as various thermally treated conditions. Microhardness was evaluated using the Vickers microhardness test, and in accordance with ASTM standard E92-17 and ASTM E384. Results from the microhardness evaluations, and the thermal treatments employed are given in Table 5, below.

TABLE 5
Microhardness Values (in HV) of Experimental
Alloys in Various Conditions

| Alloy | As re-melted | Condition (A) | Condition (B) | Condition (C) |
|---|---|---|---|---|
| 1 | 202 | 192 | 184 | 208 |
| 2 | 146 | 136 | 137 | 132 |
| 3 | 166 | 171 | 172 | 179 |
| 4 | 213 | 210 | 197 | 190 |
| 5 | 221 | 171 | 181 | 158 |
| 6 | 237 | 201 | 209 | 174 |
| 7 | 261 | 233 | 267 | 219 |
| 8 | 140 | 128 | 128 | 117 |
| 9 | 156 | 155 | 154 | 159 |
| 10 | 207 | 203 | 215 | 201 |
| 11 | 218 | 229 | 209 | 174 |
| 12 | 232 | 209 | 256 | 223 |
| 13 | 350 | 313 | 285 | 271 |
| 14 | 274 | 212 | 198 | 192 |

Condition (A) = Thermally exposed to 300° C. for 24 hours
Condition (B) = Thermally exposed to 300° C. for 24 hours and then to 230° C. for 100 hours
Condition (C) = Thermally exposed to 300° C. for 24 hours and then to 300° C. for 100 hours

The tendency for the materials to crack was evaluated using micrograph inspection. In this regard, all of the experimental alloys except for Alloy 13 were free of cracks in the as re-melted condition. However, it is believed that, inter alia, the cracking could be eliminated by modifying the experimental parameters and/or by modifying the alloy composition with grain refiner(s).

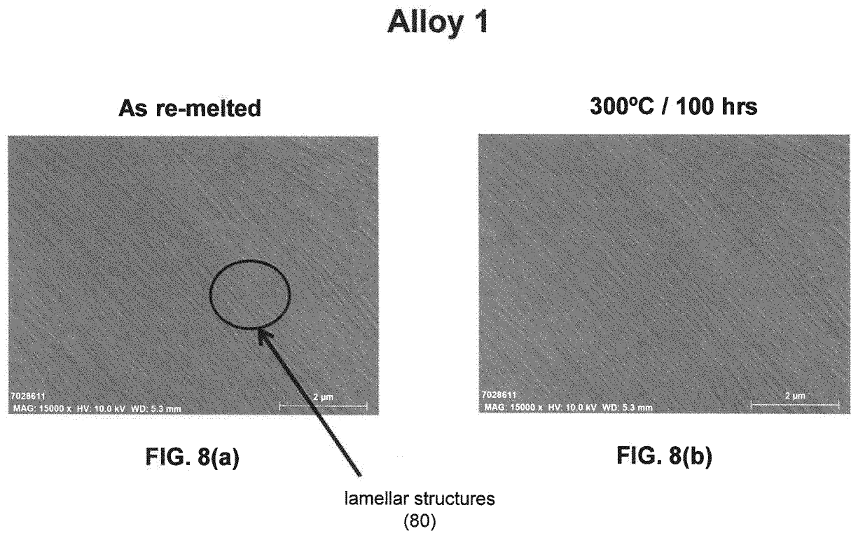

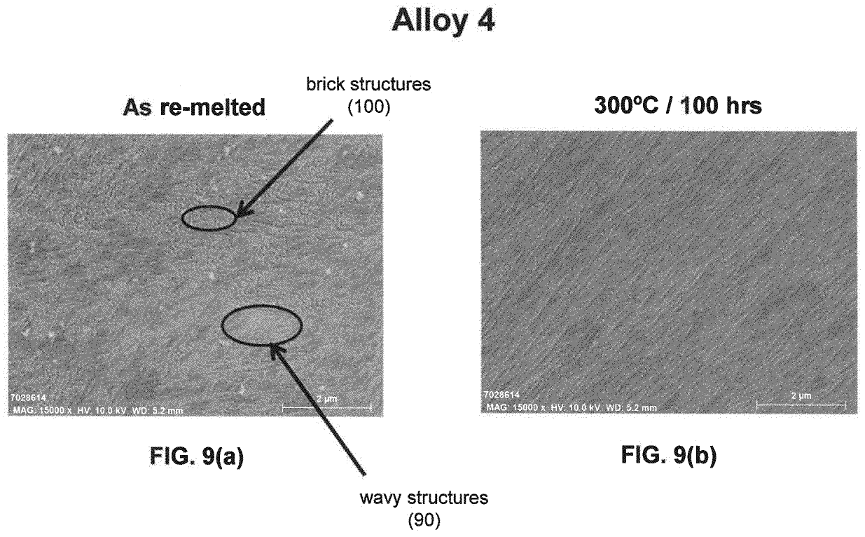

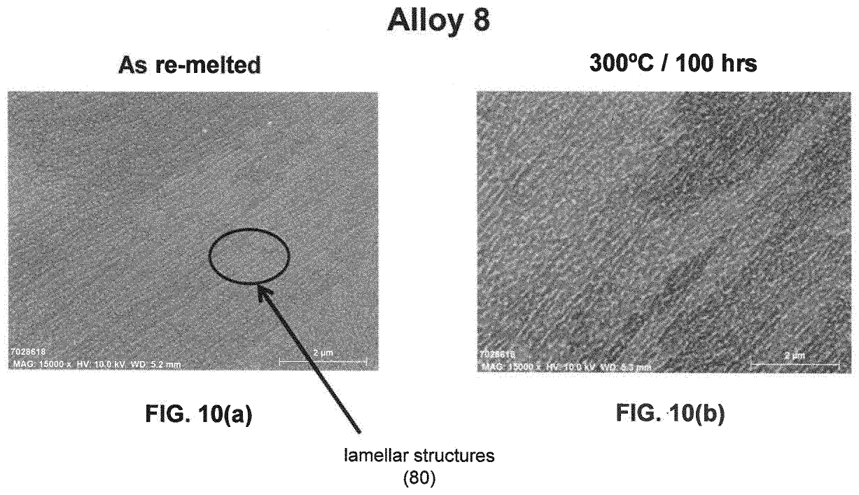

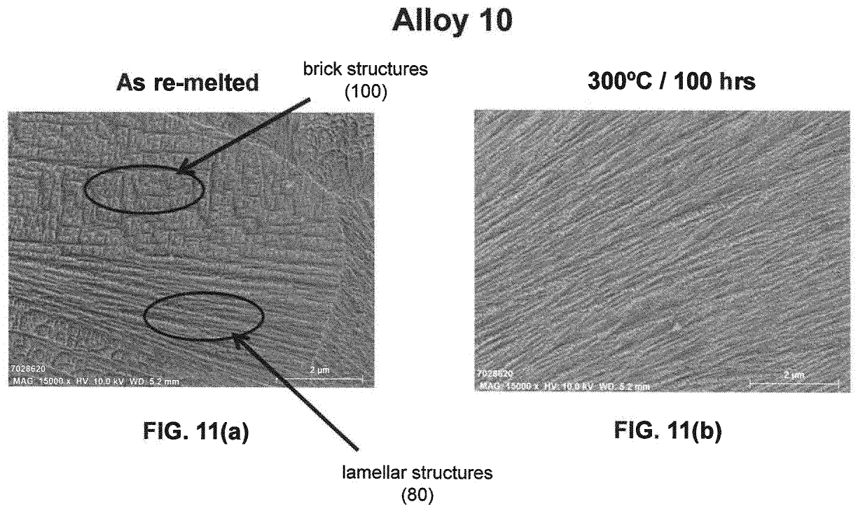

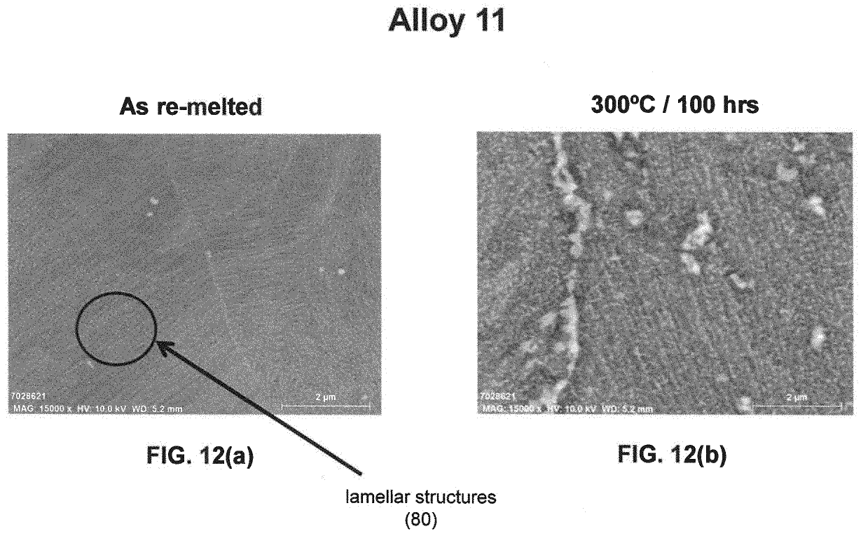

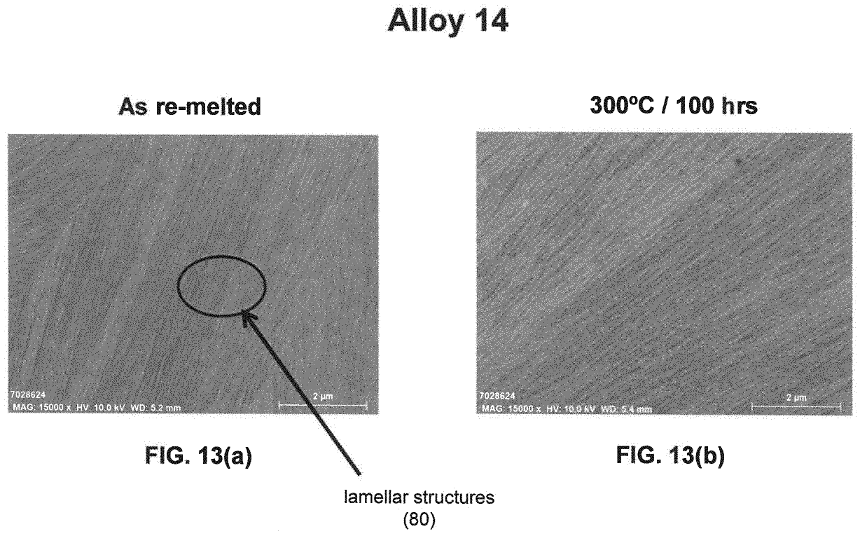

Micrographs of Alloys 1, 4, 8, 10, 11, and 14 in Condition (C) are shown in FIGS. 8(a)-13(b). Illustrative examples of fine eutectic-type structures, such as lamellar (80), wavy (90), and brick (100) structures, are shown in FIGS. 8(a)-13(b). FIGS. 8(a)-13(b) also demonstrate the thermal stability of the experimental alloys. Alloys that generally retained their as-built fine eutectic-type structures after thermal exposure include alloys 1, 4, 10, and 14. Alloys 1 and 14 retained their lamellar structures (80), alloy 4 retained its wavy structures (90), and alloy 10 retained its lamellar structures (80). While FIGS. 4(b) and 10(b) do not show brick structures (100), this is believed to be due to regional differences in microstructure. Alloys that did not retain their fine eutectic-type structures after thermal exposure include alloys 8 and 11; these alloys coarsened after thermal exposure, as illustrated in FIGS. 10(a)-(b) and 12(a)-(b). These results indicate that sufficient amounts of iron and rare earth elements should be used in the alloy when thermal stability is an important property.

### EXAMPLE 4

Three additional experimental alloys were tested in accordance with the procedure outlined in above Example 3. These alloys included grain refiners. The compositions of these alloys are given in Table 6, below.

TABLE 6
Experimental Alloy Compositions (in wt. %)

| Alloy No. | Fe | Ce | La | Ce + La | Fe + RE | Ti | B |
|---|---|---|---|---|---|---|---|
| Alloy 15 | 4.8 | 5.1 | 2.3 | 7.4 | 12.2 | 1.1 | 0.31 |
| Alloy 16 | 4.2 | 1.3 | 0.61 | 1.91 | 6.11 | 1.2 | 0.34 |
| Alloy 17 | 7.2 | 2.5 | 1.3 | 3.8 | 11.0 | 2.4 | 0.71 |

*The balance of the alloys was aluminum and impurities.

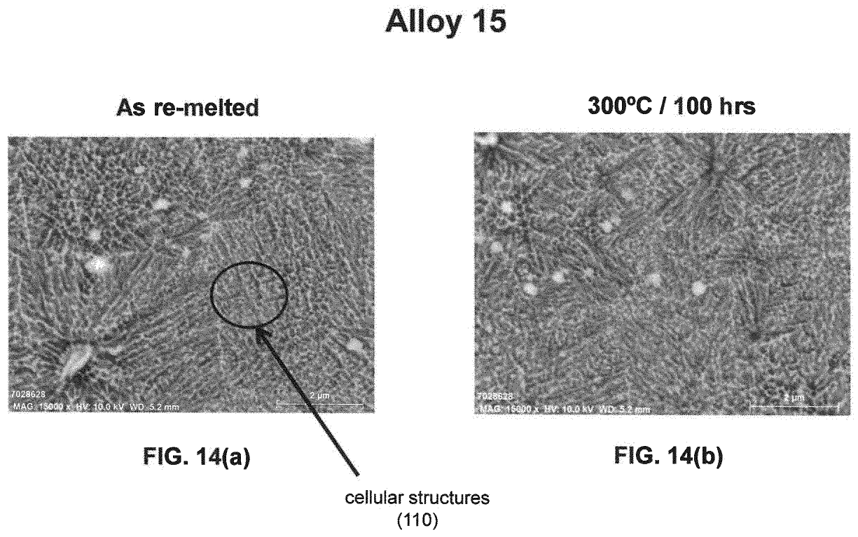

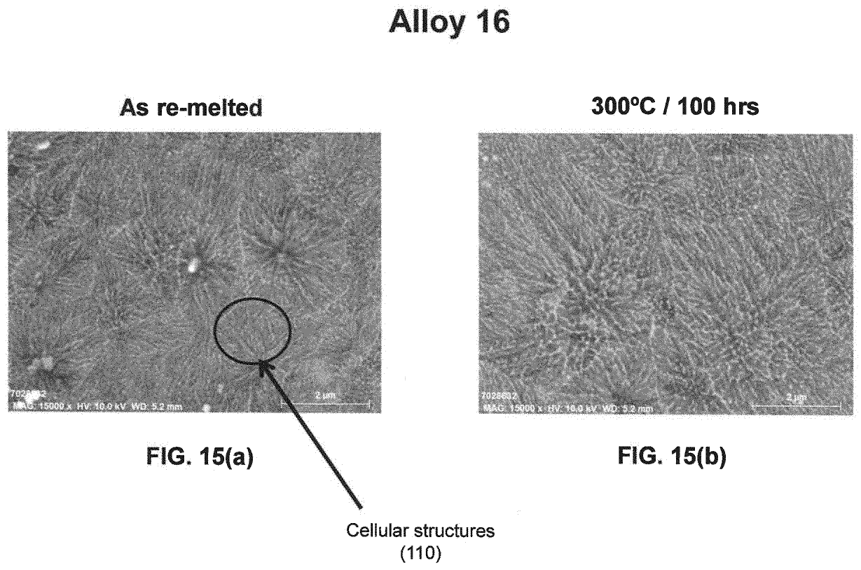

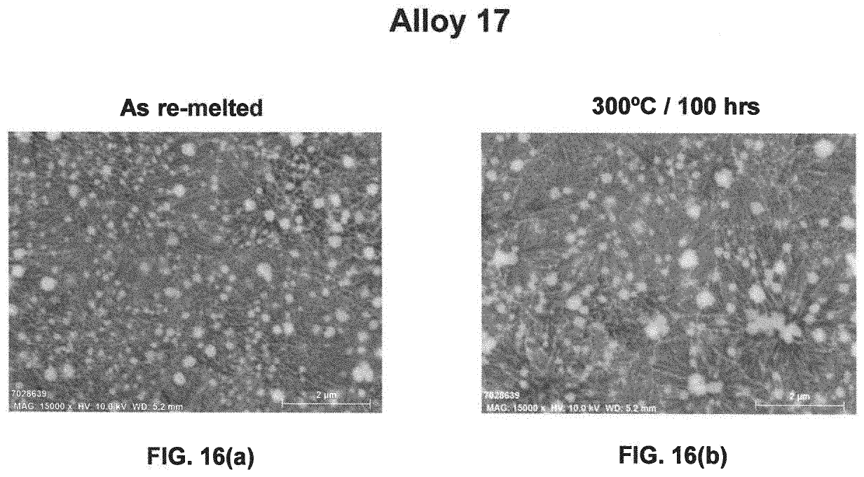

Alloys 15-17 were similarly inspected for cracking by micrograph inspection. All of Alloys 15-17 were free of cracks in the as re-melted condition. Micrographs of Alloys 15-17 in Condition (C) are shown in FIGS. 14(a)-16(b). Illustrative examples of fine eutectic-type structures, such as cellular structures (110), are shown in FIGS. 14(a)-16(b). In contrast to Alloys 1-14, Alloys 15-17 exhibited generally cellular structures. While not being bound by any theory, it is believed that the presence of the grain refiners (TiB₂ and titanium, in this case) may facilitate the production of the cellular structures.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated). Accordingly, although various example embodiments have been disclosed, a worker of ordinary skill in the art would recognize that certain modifications would come within the scope of this disclosure. For at least that reason, the following claims should be studied to determine the scope and content of this disclosure.

What is claimed is:

1. A method comprising:
(a) using a feedstock in an additive manufacturing apparatus, wherein the feedstock comprises an alloy having:
from 1 to 15 wt. % Fe; and
from 1 to 20 wt. % of at least one rare earth (RE) element,
wherein RE (wt. %)≥−3.11(wt. % Fe)+13.4; and/or
wherein RE (wt. %)≤−3.11(wt. % Fe)+38;
the balance being aluminum and any optional incidental elements and impurities; and
(b) producing an additively manufactured body in the additive manufacturing apparatus using the feedstock, wherein the additively manufactured body comprises at least 10-40 vol. % of Al—Fe-RE intermetallics.

2. The method of claim 1, wherein the additively manufactured body comprises not greater than 20 vol. % of large Al—Fe-RE spheroid particles.

3. The method of claim 1, wherein the additively manufactured body realizes a fine eutectic-type microstructure.

4. The method of claim 3, wherein the fine eutectic-type microstructure comprises at least one of spheroidal, cellular, lamellar, wavy, and brick structures.

5. The method of claim 4, wherein an average spacing between eutectic structures is not greater than 5 micrometers

6. The method of claim 1, wherein the feedstock comprises 5-11 wt. % Fe and 2.5-10 wt. % of the at least one rare earth element.

7. The method of claim 1, wherein the (wt. % Fe) plus the (wt. % of the at least one rare earth (RE) element) is at least 9 wt. %.

8. The method of claim 1, wherein the aluminum alloy body realizes a tensile yield strength-to-elongation relationship satisfying the following empirical relationship as measured at 230° C.:
TYS≥−5.0808*(elongation)²+22.274*(elongation)+337.08,
when annealed at 300° C. for 24 hours followed by thermal exposure at 230° C. for 1000 hours.

9. The method of claim 1, wherein the aluminum alloy product is in the form of an engine component for an aerospace or automotive vehicle, wherein the method comprises:
incorporating the engine component into the aerospace or automotive vehicle; and
operating the aerospace or automotive vehicle.

10. The method of claim 9, wherein the aluminum alloy product is a compressor wheel for a turbocharger.

11. The method of claim 1, wherein:
RE(wt. %)≥−3.11(wt. % Fe)+18; and
RE (wt. %)≤−3.11(wt. % Fe)+34.75.

12. An additively manufactured aluminum alloy product comprising:
from 1 to 15 wt. % Fe; and
from 1 to 20 wt. % of at least one rare earth (RE) element,
wherein RE (wt. %)≥−3.11(wt. % Fe)+13.4; and/or
wherein RE (wt. %)≤−3.11(wt. % Fe)+38;
the balance being any optional incidental elements and impurities, wherein the additively manufactured aluminum alloy product comprises a fine eutectic-type microstructure, wherein the fine eutectic-type microstructure comprises at least one of spheroidal, cellular, lamellar, wavy, and brick structures, and wherein an average spacing between eutectic structures is not greater than 5 micrometers

13. The additively manufactured aluminum alloy product of claim 12, wherein the additively manufactured aluminum alloy product comprises 5-11 wt. % Fe and 2.5-10 wt. % of the at least one rare earth element, and wherein the (wt. % Fe) plus the (wt. % of the at least one rare earth (RE) element) is at least 9 wt. %.

14. The additively manufactured aluminum alloy product of claim 12, wherein the additively manufactured aluminum alloy product comprises 10-40 vol. % of Al—Fe-RE intermetallics.

15. The additively manufactured aluminum alloy product of claim 12, wherein the additively manufactured aluminum alloy product comprises not greater than 20 vol. % of large Al—Fe-RE spheroid particles.

16. The additively manufactured aluminum alloy product of claim 12, wherein the additively manufactured aluminum alloy product realizes a tensile yield strength-to-elongation relationship satisfying the following empirical relationship as measured at 230° C.:
TYS≥−5.0808*(elongation)²+22.274*(elongation)+337.08,
when annealed at 300° C. for 24 hours followed by thermal exposure at 230° C. for 1000 hours.

17. The additively manufactured aluminum alloy product of claim 12, wherein the additively manufactured aluminum alloy product is free of grain refiners.

18. The additively manufactured aluminum alloy product of claim 17, wherein the additively manufactured aluminum alloy product comprises columnar grains.

19. The additively manufactured aluminum alloy product of claim 12, wherein the additively manufactured aluminum alloy includes from 0.1 to 5 wt. % of one or more grain refiners.

20. The additively manufactured aluminum alloy product of claim 19, wherein the additively manufactured aluminum alloy product comprises equiaxed grains having an average grain size of from 0.05 to 50 microns.
